(19) United States
(12) Patent Application Publication
(10) Pub. No.: US 2025/0290765 A1
(43) Pub. Date: Sep. 18, 2025

(54) INFORMATION PROCESSING DEVICE, INFORMATION PROCESSING METHOD, AND IMAGE PROJECTING SYSTEM

(71) Applicant: Mitsubishi Electric Corporation, Tokyo (JP)

(72) Inventors: Kenji ISHIDA, Tokyo (JP); Masato HIRAI, Tokyo (JP); Masami HAGIWARA, Tokyo (JP)

(73) Assignee: Mitsubishi Electric Corporation, Tokyo (JP)

(21) Appl. No.: 19/223,106

(22) Filed: May 30, 2025

Related U.S. Application Data
(63) Continuation of application No. PCT/JP2023/003131, filed on Feb. 1, 2023.

(51) Int. Cl. G01C 21/36; G06T 11/00; H04N 5/74

(52) U.S. Cl. CPC G01C 21/365; G06T 11/00; H04N 5/74

(57) ABSTRACT

There are included: an area information acquiring unit to acquire area information regarding a projection area of a projecting device; a route condition acquiring unit to acquire a route condition of a route to be projected on an area indicated by the area information; a mark acquiring unit to acquire a mark condition regarding a mark; and an information processing unit to generate and output an image in which a mark satisfying the mark condition is arranged along a route satisfying the route condition in the projection area.

### CROSS-REFERENCE TO RELATED APPLICATION

This disclosure is a continuation of International Patent Application No. PCT/JP2023/003131, filed on Feb. 1, 2023, the entire contents of which are incorporated herein by reference.

### TECHNICAL FIELD

The present disclosure relates to an information processing technology related to a projected image.

### BACKGROUND ART

Some information processing technologies related to images generate and output an image indicating a mark that is a movement target of a user.

For example, Patent Literature 1 discloses that an “image projecting device such as a projector” arranges and projects a “target image” (corresponding to the “mark”), which is an “image indicating a moving target position”, from a position facing the image projecting device toward the image projecting device. (See paragraph of Patent Literature 1, and FIGS. 5, 6, 12, and the like)

According to the technique disclosed in Patent Literature 1, in a projection area of an image projecting device, a mark is projected so as to extend straight from a position facing the image projecting device in a direction approaching the image projecting device.

### CITATION LIST

### Patent Literature

Patent Literature 1: JP 2018-161529 A

### SUMMARY OF INVENTION

### Technical Problem

However, the technology disclosed in Patent Literature 1 only illustrates a route extending straight from a position facing the image projecting device in the projection area in a direction approaching the image projecting device, and has a problem that the route cannot be changed.

The present disclosure has been made to solve the above problems, and an object of the present disclosure is to provide an information processing technology that makes a route in a projection area variable.

### Solution to Problem

An information processing device of the present disclosure includes:
a processor; and a memory storing a program, upon executed by the processor, to perform a process:
to acquire area information regarding a projection area of a projecting device;
to acquire a route condition of a route to be projected on an area indicated by the area information;
to acquire a mark condition regarding a mark; and
to generate and output an image in which a mark satisfying the mark condition is arranged along a route satisfying the route condition in the projection area.

### Advantageous Effects of Invention

According to the present disclosure, there is an effect that a route in a projection area can be made variable.

### BRIEF DESCRIPTION OF DRAWINGS

FIG. 1 is a diagram illustrating a configuration example of an image projecting system 1 including an information processing device 100 of the present disclosure.

FIG. 2 is a diagram illustrating a configuration example of an information processing device 100A and an image projecting system 1A according to a first embodiment of the present disclosure.

FIG. 3 is a diagram illustrating a configuration example of an information processing unit 140 in the information processing device 100A according to the first embodiment of the present disclosure.

FIG. 4 is a flowchart illustrating an example of processing of the information processing device 100A according to the first embodiment of the present disclosure.

FIG. 5 is a flowchart illustrating an example of image generation output processing in processing of the information processing device 100A according to the first embodiment of the present disclosure.

FIG. 6 is a flowchart illustrating an example of route generation processing in processing of the information processing device 100A according to the first embodiment of the present disclosure.

FIG. 7 is a flowchart illustrating an example of mark arrangement processing in processing of the information processing device 100A according to the first embodiment of the present disclosure.

FIG. 8 is a diagram illustrating a configuration example of an information processing device 100B and an image projecting system B according to a second embodiment of the present disclosure.

FIG. 9A is a diagram for describing a first concept of route components used in the information processing device 100B according to the second embodiment of the present disclosure.

FIG. 9B is a diagram for describing a second concept of the route components used in the information processing device 100B according to the second embodiment of the present disclosure.

FIG. 9C is a diagram for describing a third concept of the route components used in the information processing device 100B according to the second embodiment of the present disclosure.

FIG. 9D is a diagram for describing a fourth concept of the route components used in the information processing device 100B according to the second embodiment of the present disclosure.

FIG. 9E is a diagram for describing a fifth concept of the route components used in the information processing device 100B according to the second embodiment of the present disclosure.

FIG. 9F is a diagram for describing a sixth concept of the route components used in the information processing device 100B according to the second embodiment of the present disclosure.

FIG. 9G is a diagram for describing a seventh concept of the route components used in the information processing device 100B according to the second embodiment of the present disclosure.

FIG. 9H is a diagram for describing an eighth concept of the route components used in the information processing device 100B according to the second embodiment of the present disclosure.

FIG. 9I is a diagram for describing a ninth concept of the route components used in the information processing device 100B according to the second embodiment of the present disclosure.

FIG. 9J is a diagram for describing a 10th concept of the route components used in the information processing device 100B according to the second embodiment of the present disclosure.

FIG. 9K is a diagram for describing a 11th concept of the route components used in the information processing device 100B according to the second embodiment of the present disclosure.

FIG. 9L is a diagram for describing a 12th concept of the route components used in the information processing device 100B according to the second embodiment of the present disclosure.

FIG. 9M is a diagram for describing a 13th concept of the route components used in the information processing device 100B according to the second embodiment of the present disclosure.

FIG. 9N is a diagram for describing a 14th concept of the route components used in the information processing device 100B according to the second embodiment of the present disclosure.

FIG. 9O is a diagram for describing a 15th concept of the route components used in the information processing device 100B according to the second embodiment of the present disclosure.

FIG. 9P is a diagram for describing a 16th concept of the route components used in the information processing device 100B according to the second embodiment of the present disclosure.

FIG. 10 is a diagram illustrating examples of marks used in an information processing device 100B according to the second embodiment of the present disclosure.

FIG. 11A is a diagram illustrating a first example of an image output by an information processing device 100B or an image projected by the image projecting system 1B according to the second embodiment of the present disclosure.

FIG. 11B is a diagram illustrating a second example of an image output by the information processing device 100B or an image projected by the image projecting system 1B according to the second embodiment of the present disclosure.

FIG. 11C is a diagram illustrating a third example of an image output by the information processing device 100B or an image projected by the image projecting system 1B according to the second embodiment of the present disclosure.

FIG. 11D is a diagram illustrating a fourth example of an image output by the information processing device 100B or an image projected by the image projecting system 1B according to the second embodiment of the present disclosure.

FIG. 11E is a diagram illustrating a fifth example of an image output by the information processing device 100B or an image projected by the image projecting system 1B according to the second embodiment of the present disclosure.

FIG. 11F is a diagram illustrating a sixth example of an image output by the information processing device 100B or an image projected by the image projecting system 1B according to the second embodiment of the present disclosure.

FIG. 11G is a diagram illustrating a seventh example of an image output by the information processing device 100B or an image projected by the image projecting system 1B according to the second embodiment of the present disclosure.

FIG. 11H is a diagram illustrating an eighth example of an image output by the information processing device 100B or an image projected by the image projecting system 1B according to the second embodiment of the present disclosure.

FIG. 11I is a diagram illustrating a ninth example of an image output by the information processing device 100B or an image projected by the image projecting system 1B according to the second embodiment of the present disclosure.

FIG. 11J is a diagram illustrating a tenth example of an image output by the information processing device 100B or an image projected by the image projecting system 1B according to the second embodiment of the present disclosure.

FIG. 11K is a diagram illustrating an 11th example of an image output by the information processing device 100B or an image projected by the image projecting system 1B according to the second embodiment of the present disclosure.

FIG. 11L is a diagram illustrating a 12th example of an image output by the information processing device 100B or an image projected by the image projecting system 1B according to the second embodiment of the present disclosure.

FIG. 12 is a diagram illustrating a configuration example of an information processing device 100C and an image projecting system 1C according to a third embodiment of the present disclosure.

FIG. 13 is a diagram illustrating a configuration example of an information processing unit 140C in the information processing device 100C according to the third embodiment of the present disclosure.

FIG. 14 is a flowchart illustrating an example of mark arrangement processing in processing of the information processing device 100C according to the third embodiment of the present disclosure.

FIG. 15A is a diagram for describing a first concept of a shadow occurrence route used in the information processing device 100C according to the third embodiment of the present disclosure.

FIG. 15B is a diagram for describing a second concept of a shadow occurrence route used in the information processing device 100C according to the third embodiment of the present disclosure.

FIG. 15C is a diagram for describing a third concept of a shadow occurrence route used in the information processing device 100C according to the third embodiment of the present disclosure.

FIG. 15D is a diagram for describing a fourth concept of a shadow occurrence route used in the information processing device 100C according to the third embodiment of the present disclosure.

FIG. 16A is a diagram illustrating a first example of an image output by the information processing device 100C or an image projected in the image projecting system 1C according to the third embodiment of the present disclosure.

FIG. 16B is a diagram illustrating a second example of an image output by the information processing device 100C or an image projected in the image projecting system 1C according to the third embodiment of the present disclosure.

FIG. 16C is a diagram illustrating a third example of an image output by the information processing device 100C or an image projected in the image projecting system 1C according to the third embodiment of the present disclosure.

FIG. 16D is a diagram illustrating a fourth example of an image output by the information processing device 100C or an image projected in the image projecting system 1C according to the third embodiment of the present disclosure.

FIG. 17 is a diagram illustrating a configuration example of the information processing device 100D and an image projecting system 1D according to a fourth embodiment of the present disclosure.

FIG. 18 is a flowchart illustrating an example of processing of the information processing device 100D according to the fourth embodiment of the present disclosure.

FIG. 19 is a flowchart illustrating an example of image generation output processing in processing of the information processing device 100D according to the fourth embodiment of the present disclosure.

FIG. 20 is a flowchart illustrating an example of route generation processing in processing of the information processing device 100D according to the fourth embodiment of the present disclosure.

FIG. 21A is a diagram illustrating a first example of an image output by the information processing device 100D or an image projected in the image projecting system 1D according to the fourth embodiment of the present disclosure.

FIG. 21B is a diagram illustrating a second example of an image output by the information processing device 100D or an image projected in the image projecting system 1D according to the fourth embodiment of the present disclosure.

FIG. 21C is a diagram illustrating a third example of an image output by the information processing device 100D or an image projected in the image projecting system 1D according to the fourth embodiment of the present disclosure.

FIG. 21D is a diagram illustrating a fourth example of an image output by the information processing device 100D or an image projected in the image projecting system 1D according to the fourth embodiment of the present disclosure.

FIG. 21E is a diagram illustrating a fifth example of an image output by the information processing device 100D or an image projected in the image projecting system 1D according to the fourth embodiment of the present disclosure.

FIG. 21F is a diagram illustrating a sixth example of an image output by the information processing device 100D or an image projected in the image projecting system 1D according to the fourth embodiment of the present disclosure.

FIG. 22 is a diagram illustrating a first example of a hardware configuration for implementing functions of the information processing devices 100, 100A, 100B, 100C, and 100D of the present disclosure.

FIG. 23 is a diagram illustrating a second example of a hardware configuration for implementing the functions of the information processing devices 100, 100A, 100B, 100C, and 100D of the present disclosure.

### DESCRIPTION OF EMBODIMENTS

Hereinafter, in order to describe the present disclosure in more detail, embodiments of the present disclosure will be described with reference to the accompanying drawings.

### First Embodiment

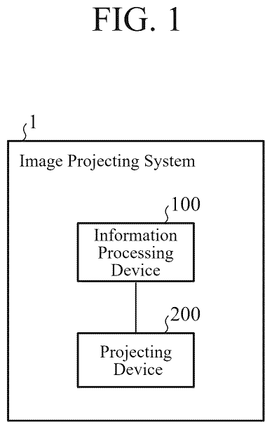

FIG. 1 is a diagram illustrating a configuration example of an image projecting system 1 including an information processing device 100 of the present disclosure.

The image projecting system 1 is, for example, a system that projects an image on an area where a user walks.

The image projecting system 1 illustrated in FIG. 1 includes an information processing device 100 and a projecting device 200.

The information processing device 100 generates and outputs an image projected by the projecting device 200.

Specifically, the information processing device 100 acquires area information regarding a projection area of the projecting device 200, acquires a route condition of a route to be projected on an area indicated by the area information, and acquires a mark condition regarding a mark to be projected.

The information processing device 100 generates and outputs an image in which marks satisfying the mark condition are arranged along a route satisfying the route condition in the projection area.

The projecting device 200 is an output device such as a projector.

The projecting device 200 receives an image from the information processing device 100 and projects the received image onto a projection target object such as a floor surface. The entire area of the range projected by the projecting device 200 is referred to as a projection area.

A detailed configuration example of an information processing device and an image projecting system including the information processing device will be described.

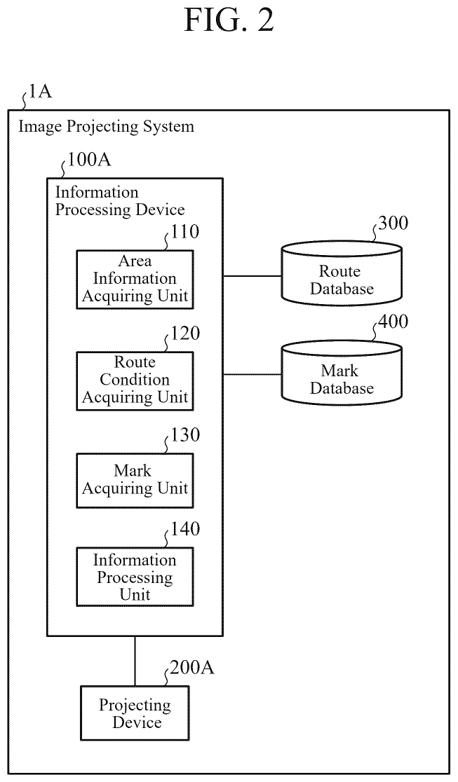

FIG. 2 is a diagram illustrating a configuration example of an information processing device 100A and an image projecting system 1A according to a first embodiment of the present disclosure.

The image projecting system 1A illustrated in FIG. 2 includes the information processing device 100A, a projecting device 200A, a route database 300, and a mark database 400.

The information processing device 100A has functions similar to those of the information processing device described above.

Specifically, the information processing device 100A illustrated in FIG. 2 includes an area information acquiring unit 110, a route condition acquiring unit 120, a mark acquiring unit 130, and an information processing unit 140.

The information processing device 100A includes a control unit which is not illustrated, a storage unit which is not illustrated, and a communication unit which is not illustrated as components to be mounted on a general computer.

The area information acquiring unit 110 acquires area information regarding a projection area of the projecting device 200A.

The area information acquiring unit 110 acquires, for example, the area information regarding the projection area of the projecting device 200A stored in advance. In this case, the area information is stored in advance in the projecting device 200A, the information processing device 100A, or the image projecting system 1A.

Alternatively, the area information acquiring unit 110 acquires, for example, area information input to the information processing device 100A by an operator of the information processing device 100A.

The route condition acquiring unit 120 acquires a route condition of a route to be projected on the area indicated by the area information. The route condition newly acquired by the route condition acquiring unit 120 includes at least one of a start position, a scheduled length, or the number of direction changes. The route condition acquiring unit 120 acquires route conditions other than the route condition to be newly acquired from route conditions stored in advance in a storage unit which is not illustrated.

The start position included in the route condition is a position at which the route to be projected on the area indicated by the area information starts.

The scheduled length included in the route condition is the length of the route to be projected on the area indicated by the area information.

The number of direction changes included in the route condition is the number of changes in the traveling direction in the route to be projected on the area indicated by the area information.

The route condition may further include a shape of the route component and an end position.

The shape of the route component that can be included in the route condition is, for example, a shape such as a straight line shape, a C shape, an I shape, a J shape, an L shape, an M shape, an N shape, and an S shape.

The mark acquiring unit 130 acquires a mark condition related to a mark.

The mark included in the mark condition is one type of mark or a plurality of types of marks.

The mark condition includes identification information of the mark and an arrangement interval of each mark.

The information processing unit 140 generates and outputs an image in which marks satisfying the mark condition are arranged along a route satisfying the route condition in the projection area.

The information processing unit 140 generates and outputs an image in which marks are arranged so as to satisfy the mark condition in an area other than an area where a shadow due to a user occurs when the user is present in the projection area along a route satisfying the route condition in the projection area.

Here, a detailed configuration example of the information processing unit 140 will be described.

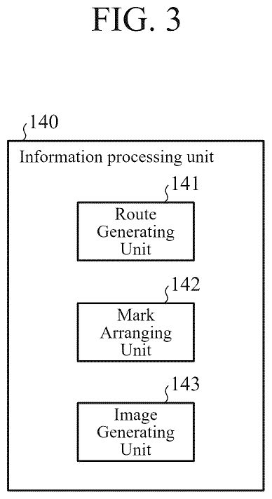

FIG. 3 is a diagram illustrating a configuration example of the information processing unit 140 in the information processing device 100A according to the first embodiment of the present disclosure.

The information processing unit 140 illustrated in FIG. 3 includes a route generating unit 141, a mark arranging unit 142, and an image generating unit 143.

The route generating unit 141 generates a route satisfying the route condition in the projection area.

Specifically, the route generating unit 141 acquires route components from route components stored in advance so as to satisfy the route condition in the range of the projection area indicated by the area information, and connects the route components to generate a route.

More specifically, the route generating unit 141 acquires the area information and the route condition, refers to the route database 300 using the area information and the route condition, and acquires the route component from among the route components stored in the route database 300 so as to satisfy the route condition in the range of the projection area indicated by the area information. The route generating unit 141 generates a route by combining the acquired route components and connecting routes in the route components. The route generating unit 141 outputs route information indicating the generated route.

The mark arranging unit 142 arranges a mark along the route generated by the route generating unit 141.

Specifically, for example, the mark arranging unit 142 acquires mark information satisfying the mark condition from the mark information stored in advance, and arranges the mark along the route generated by the route generating unit 141 using the mark information. A single or a plurality of marks is arranged. Further, there are one type or a plurality of types of marks to be arranged.

More specifically, the mark arranging unit 142 acquires the mark condition, refers to the mark database 400 using the mark condition, and acquires the mark information satisfying the mark condition. The mark arranging unit 142 arranges the mark along the route generated by the route generating unit 141 using the acquired mark information.

The mark arranging unit 142 outputs arranged mark information indicating all the arranged marks.

The image generating unit 143 outputs an image including the mark arranged by the mark arranging unit 142.

Specifically, for example, the image generating unit 143 superimposes and outputs an image indicating the route generated by the route generating unit 141 and an image indicating the marks arranged by the mark arranging unit 142.

More specifically, the image generating unit 143 acquires the route information indicating the route generated by the route generating unit 141, and acquires the arranged mark information indicating all the arranged marks arranged by the mark arranging unit 142. The image generating unit 143 generates a route image indicating the route using the route information. The image generating unit 143 generates an arranged mark image indicating arranged marks arranged according to the projection area using the arranged mark information. The image generating unit 143 outputs a projection image, which is an image obtained by superimposing the route image and the arranged mark image, to the projecting device 200A.

The projecting device 200A has a function similar to that of the projecting device 200 described above. The projecting device 200A illustrated in FIG. 2 receives an image generated and output by the image generating unit 143 in the information processing device 100A, and projects the received image by outputting the received image to a projection target object such as a floor surface. The projecting device 200A projects an image generated by the information processing device 100A in a range of a projection area to be projected.

The route database 300 stores route component information regarding route components.

Specifically, the route database 300 includes information regarding route components with which an image of a continuous route can be generated in the projection area by connecting a plurality of route components such as a start point of a route in route components, an end point of the route in the route components, a length of the route in the route components, a shape of the route in the route components, and the number of direction changes of the route in the route components, and stores the information as the route component information in association with each other.

The start point of a route and the end point of the route are, for example, information indicated by coordinates of the start point and coordinates of the end point with respect to a reference point in a route component image.

The length of the route is a length along a route from the start point to the end point in the route component image.

The shape of the route is, for example, information indicated in the form of a coordinate group indicating a boundary that separates the route and the rest in the route component image. Alternatively, for example, the image itself indicating the shape of the route in the route component may be used.

The number of direction changes of the route is information indicating the number of direction changes along the route in the route component image. For example, when the route is straight, the number of direction changes is “0”, and when the route is L-shaped, the number of direction changes is “1”. Note that, in a case where the route draws a curve, the number of direction changes may be “1” from the start point to the end point of the curve in the route, or the number of changes in direction per fixed length.

Note that, a mode in which route components stored in the route database 300 provided outside the information processing device 100A are used will be described here, but the route database 300 may be included inside the information processing device 100A.

The mark database 400 stores mark information for each mark type for a plurality of types of marks.

Specifically, the mark database 400 stores the mark identification information and the mark image in association with each other.

The types of marks include figures, characters, and the like.

The figures as types of marks include many types of figures such as a circle, a triangle, a quadrangle, a hexagon, a star, and a fruit.

The characters as types of marks include hiragana, katakana, various numbers, and characters used in each region in the world.

Note that, here, a mode in which marks stored in the mark database 400 provided outside the information processing device 100A are used will be described, but the mark database 400 may be included inside the information processing device 100A.

An example of processing of the information processing device 100A will be described.

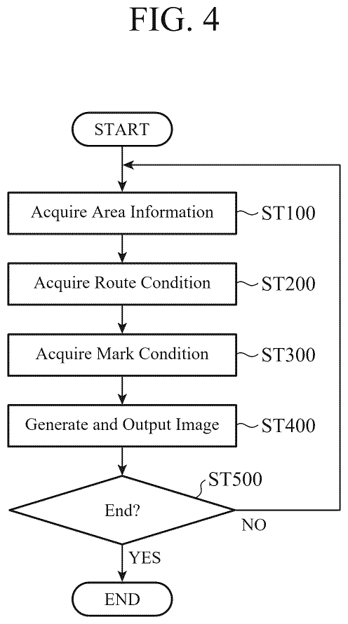

FIG. 4 is a flowchart illustrating an example of processing of the information processing device 100A according to the first embodiment of the present disclosure.

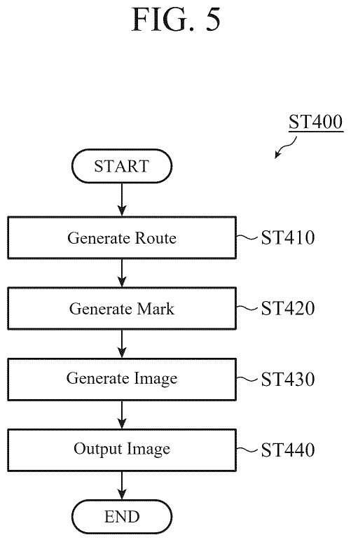

FIG. 5 is a flowchart illustrating an example of image generation output processing in the processing of the information processing device 100A according to the first embodiment of the present disclosure.

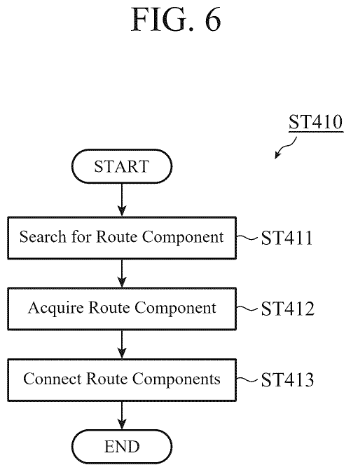

FIG. 6 is a flowchart illustrating an example of route generation processing in the processing of the information processing device 100A according to the first embodiment of the present disclosure.

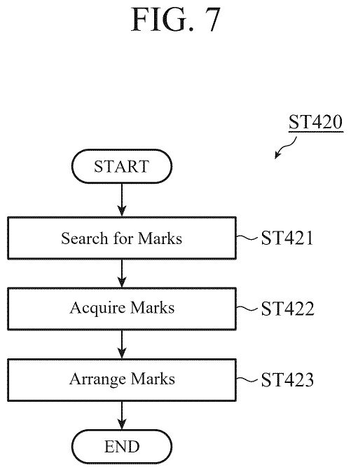

FIG. 7 is a flowchart illustrating an example of mark arrangement processing in the processing of the information processing device 100A according to the first embodiment of the present disclosure.

In the processing illustrated in FIG. 5, the information processing device 100A executes area information acquisition processing (step ST100).

In the area information acquisition processing, the area information acquiring unit 110 of the information processing device 100A acquires area information regarding the projection area of the projecting device 200A.

The area information acquiring unit 110 acquires, for example, area information stored in advance.

The area information acquiring unit 110 outputs the acquired area information to the information processing unit 140.

The information processing device 100A executes route condition acquisition processing (step ST200).

In the route condition acquisition processing, the route condition acquiring unit 120 of the information processing device 100A acquires a route condition of a route to be projected on an area indicated by the area information.

The route condition acquiring unit 120 acquires route condition information indicating route conditions such as a start position, a scheduled length, and the number of direction changes, for example.

The information processing device 100A executes mark condition acquisition processing (step ST300).

In the mark condition acquisition processing, the mark acquiring unit 130 of the information processing device 100A acquires the mark condition related to a mark to be projected on the area indicated by the area information.

The mark acquiring unit 130 acquires a mark condition on the basis of, for example, an input operation of the operator.

Alternatively, the mark acquiring unit 130 acquires the mark condition according to a predetermined rule, for example.

The information processing device 100A executes image generation output processing (step ST400).

In the image generation output processing, the information processing unit 140 of the information processing device 100A generates and outputs an image in which marks satisfying the mark condition are arranged along a route satisfying the route condition in the projection area.

A detailed example of the image generation output processing will be described with reference to FIG. 5.

The information processing unit 140 executes the route generation processing in the image generation output processing (step ST410).

Specifically, the route generating unit 141 of the information processing unit 140 acquires route components from route components stored in advance so as to satisfy the route condition in the range of the projection area indicated by the area information, and connects the route components to generate a route.

A detailed example of the route generation processing will be described with reference to FIG. 6.

Upon starting the processing, the route generating unit 141 executes route component search processing (step ST411).

In the route component search processing, the route generating unit 141 first acquires the area information from the area information acquiring unit 110, and acquires the route condition information indicating route conditions including a start position from the route condition acquiring unit 120. Next, the route generating unit 141 refers to the route database 300 using the route conditions indicated in the route condition information and searches for a route component satisfying the route condition. At this time, a plurality of route components capable of generating a route whose direction changes by the number of direction changes is searched for with the scheduled length as a route length within the range of the projection area from the start position included in the route conditions. Further, in a case where the search condition includes the shape of the route, a route component having the shape of the route included in the search condition is further searched for. A search result includes information indicating a position where each route component is arranged in the projection area or an order of connection.

The route generating unit 141 executes route component acquisition processing (step ST412).

In the route component acquisition processing, the route generating unit 141 acquires a route component from among the route components stored in the route database 300 on the basis of the search result of the route component so as to satisfy the route condition in the range of the projection area indicated by the area information.

Specifically, the route generating unit 141 acquires the route component information regarding route components from the route database 300 for each route component indicated in the search result. The route component information includes information indicating a position where each route component is arranged in the projection area or an order of connection.

The route generating unit 141 executes route component connection processing (step ST413).

In the route component connection processing, the route generating unit 141 generates a route by connecting the end point indicated in each route component and the start point other than a beginning point using the acquired route component.

Specifically, the route generating unit 141 connects each route component by using information indicating a position of arrangement in the projection area or an order of connection included in the route component information for each route component, and generates route information indicating a route after connection.

The route generating unit 141 outputs route information indicating the generated route to the mark arranging unit 142 and the image generating unit 143. The description returns to FIG. 5.

The information processing unit 140 of the information processing device 100A executes mark generation processing in the image generation output processing (step ST420).

A detailed example of the mark generation processing will be described with reference to FIG. 7.

In the mark generation processing, the mark arranging unit 142 of the information processing unit 140 first executes mark search processing (step ST421). The mark arranging unit 142 searches for mark information satisfying the mark condition from the mark information stored in advance. Specifically, upon receiving the mark condition from the mark acquiring unit 130, the mark arranging unit 142 refers to the mark database 400 using the mark condition and searches for mark information satisfying the mark condition.

Next, the mark arranging unit 142 executes mark acquisition processing of acquiring the mark information as a search result (step ST422).

Next, the mark arranging unit 142 executes the mark arrangement processing (step ST423).

The mark arranging unit 142 arranges a mark along the route generated by the route generating unit 141.

The mark arranging unit 142 outputs arranged mark information indicating all the arranged marks.

The description returns to FIG. 5.

The information processing unit 140 executes image generation processing in the image generation output processing (step ST430).

In the image generation processing, the image generating unit 143 of the information processing unit 140 superimposes and outputs the image indicating the route generated by the route generating unit 141 and the image indicating the mark arranged by the mark arranging unit 142.

Specifically, the image generating unit 143 first acquires route information indicating a route from the route generating unit 141, and acquires arranged mark information indicating all the arranged marks from the mark arranging unit 142. Next, the image generating unit 143 generates a route image indicating a route using the route information, and generates an arranged mark image indicating a mark after arrangement using the arranged mark information. Next, the image generating unit 143 generates a projection image in which the route image and the arranged mark image are superimposed.

The information processing unit 140 executes image output processing in the image generation output processing (step ST440).

In the image output processing, the image generating unit 143 of the information processing unit 140 outputs the generated projection image to the projecting device 200A.

Upon executing the image output processing, the information processing unit 140 ends the image generation output processing.

The description returns to FIG. 4.

The information processing device 100A determines whether to end the processing (step ST500).

If it is determined not to end the processing (step ST500 “NO”), the information processing device 100A returns to the processing of step ST100 and repeats the processing operation from the processing of step ST100.

If it is determined to end the processing (step ST500 “YES”), the information processing device 100A ends the processing.

With the configuration and processing as described above, it is possible to make the route to be projected on the projection area variable.

The information processing device of the present disclosure is configured as follows.

“An information processing device including:
an area information acquiring unit to acquire area information regarding a projection area of a projecting device;
a route condition acquiring unit to acquire a route condition of a route to be projected on an area indicated by the area information;
a mark acquiring unit to acquire a mark condition regarding a mark; and
an information processing unit to generate and output an image in which a mark satisfying the mark condition is arranged along a route satisfying the route condition in the projection area.”

Thus, the present disclosure has an effect that it is possible to provide an information processing device that makes a route in the projection area variable.

The information processing method of the present disclosure is configured as follows.

“An information processing method including:
an area information acquisition step of acquiring, by an area information acquiring unit, area information regarding a projection area of a projecting device;
a route condition acquisition step of acquiring, by a route condition acquiring unit, a route condition of a route to be projected on an area indicated by the area information;
a mark acquisition step of acquiring, by a mark acquiring unit, a mark condition regarding a mark; and
an information processing step of generating and outputting, by an information processing unit, an image in which a mark satisfying the mark condition is arranged along a route satisfying the route condition in the projection area.”

Thus, the present disclosure has an effect that it is possible to provide an information processing method that makes a route in the projection area variable.

The image projecting system of the present disclosure is configured as follows.

“An image projecting system including:
an information processing device including:
an area information acquiring unit to acquire area information regarding a projection area of a projecting device;
a route condition acquiring unit to acquire a route condition of a route to be projected on an area indicated by the area information;
a mark acquiring unit to acquire a mark condition regarding a mark; and
an information processing unit to generate and output an image in which a mark satisfying the mark condition is arranged along a route satisfying the route condition in the projection area; and
a projecting device to project the image output by the information processing device.”

Thus, the present disclosure has an effect that it is possible to provide an image projecting system that makes a route in the projection area variable.

The information processing device of the present disclosure is further configured as follows.

“The information processing device, in which the information processing unit generates and outputs an image in which a mark is arranged so as to satisfy the mark condition in an area other than an area where a shadow due to a user occurs when the user is present in the projection area along a route satisfying the route condition in the projection area.”

Thus, the present disclosure further has an effect that it is possible to provide an information processing device capable of projecting a mark to be projected in a projection area so as not to be hidden by a shadow of a user.

Furthermore, the present disclosure has an effect similar to the above effect by applying the above configuration to the above information processing method or the above image projecting system.

The information processing device of the present disclosure is further configured as follows.

“The information processing device, in which
the information processing unit includes:
a route generating unit to acquire a route component from route components stored in advance and connect the route component to generate a route so as to satisfy the route condition in a range of a projection area indicated by the area information;
a mark arranging unit to acquire mark information satisfying the mark condition from mark information stored in advance and arrange a mark along a route generated by the route generating unit by using the mark information; and
an image generating unit to output an image indicating the route generated by the route generating unit and an image indicating the mark arranged by the mark arranging unit in a superimposed manner.”

Thus, the present disclosure has an effect that it is possible to provide an information processing device that makes a route in the projection area variable. Further, the present disclosure further has an effect that it is possible to provide an information processing device that outputs images of more types of routes with respect to an image projected on a projection area.

Furthermore, the present disclosure has an effect similar to the above effect by applying the above configuration to the above information processing method or the above image projecting system.

The information processing device of the present disclosure is further configured as follows.

“The information processing device, in which
the route condition includes:
a scheduled length that is a length of a route to be projected on an area indicated in the area information;
a start position of a route to be projected on an area indicated in the area information; or
a number of direction changes of a route to be projected on an area indicated in the area information.”

Thus, the present disclosure has an effect that it is possible to further provide an information processing device capable of generating an image indicating a route suitable for the user with respect to the image projected on the projection area.

Furthermore, the present disclosure has an effect similar to the above effect by applying the above configuration to the above information processing method or the above image projecting system.

The information processing device of the present disclosure is further configured as follows.

“The information processing device, in which the mark condition includes identification information of a mark and an arrangement interval of each of marks.”

Thus, the present disclosure has an effect that it is possible to further provide an information processing device capable of generating an image indicating marks of types and at arrangement intervals suitable for the user with respect to the image projected on the projection area.

Furthermore, the present disclosure has an effect similar to the above effect by applying the above configuration to the above information processing method or the above image projecting system.

### Second Embodiment

In a case where the route is variable in the projection area, there is a case where a route or a mark cannot be seen due to a shadow due to the user. For example, when it is considered to change the traveling direction of the route to the opposite direction in the technology of Patent Literature 1, the mark cannot be seen due to a shadow due to a pedestrian (user), and it is difficult to change the route. Further, in the technology of Patent Literature 1, it is practically difficult to extend the projection area indefinitely in the projecting direction of the image projecting device, and in a case where the projection area is a limited fixed area, the length of the route cannot be changed to be longer.

On the other hand, the second embodiment is an embodiment in which a route is not generated in an area where a shadow is likely to occur when the user is present.

In the description of the second embodiment, the description of the configuration described in the first embodiment may be appropriately omitted.

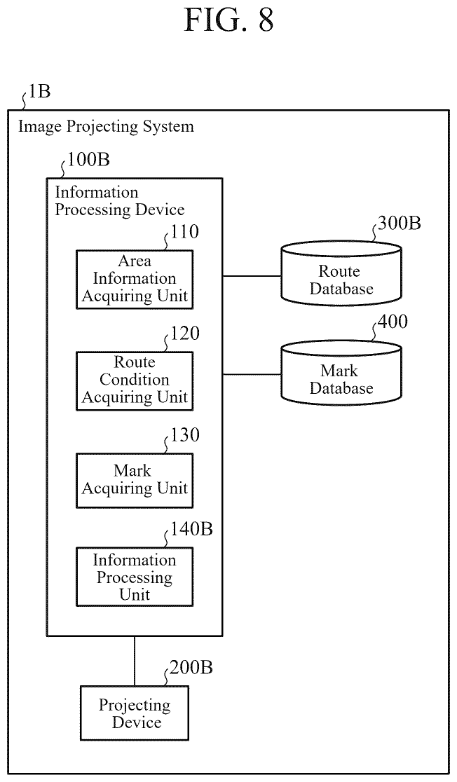

FIG. 8 is a diagram illustrating a configuration example of an information processing device 100B and an image projecting system 1B according to the second embodiment of the present disclosure.

The image projecting system 1B illustrated in FIG. 8 includes an information processing device 100B, a projecting device 200B, a route database 300B, and a mark database 400.

The information processing device 100B has a function similar to that of the information processing device 100A described above.

The projecting device 200B is similar to the projecting device 200 or the projecting device 200A described above, and a detailed description thereof will be omitted.

The mark database 400 is similar to the mark database 400 described above, and a detailed description thereof will be omitted.

The route database 300B stores route components.

Specifically, the route database 300B stores route component information regarding route components indicating a route pattern in which a shadow due to the presence of the user does not occur. A form example of the route component information is similar to the form example described above, and a detailed description thereof will be omitted. The image of the route component stored in the route database 300B will be described later.

Specifically, the information processing device 100B illustrated in FIG. 8 includes an area information acquiring unit 110, a route condition acquiring unit 120, a mark acquiring unit 130, and an information processing unit 140B.

The area information acquiring unit 110 is similar to the area information acquiring unit 110 described above, and a detailed description thereof will be omitted.

The route condition acquiring unit 120 is similar to the route condition acquiring unit 120 described above, and a detailed description thereof will be omitted.

The mark acquiring unit 130 is similar to the mark acquiring unit 130 described above, and a detailed description thereof will be omitted.

The information processing unit 140B generates and outputs an image in which marks are arranged so as to satisfy the mark condition in an area other than an area where a shadow due to a user occurs when the user is present in the projection area along a route satisfying the route condition in the projection area.

A route generating unit (not illustrated) in the information processing unit 140B acquires, from the route database 300B, route components indicating a route pattern in which a shadow due to the presence of the user does not occur.

Concepts of route components used in the information processing device 100B and route components stored in the route database 300B will be described.

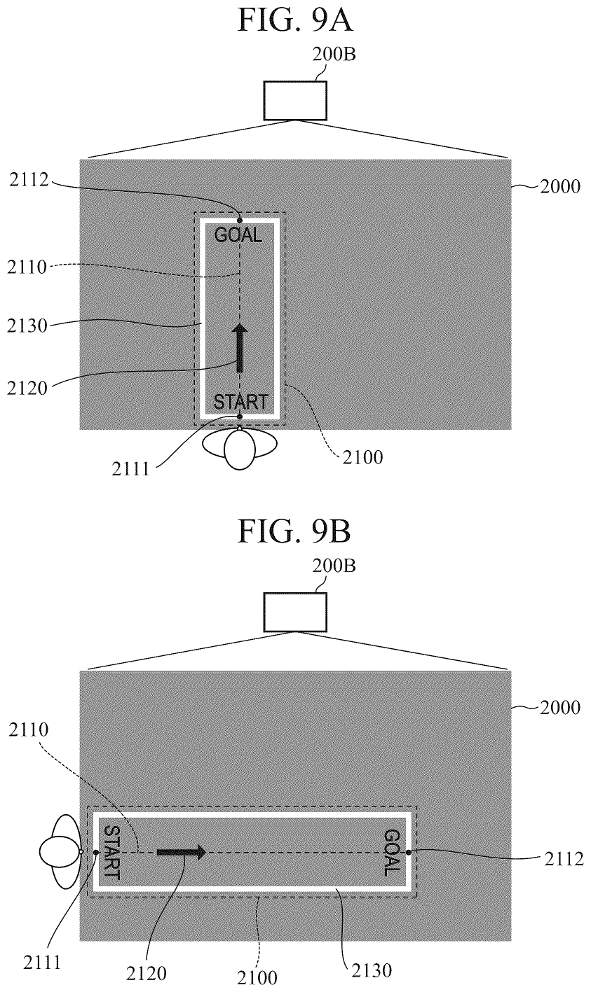

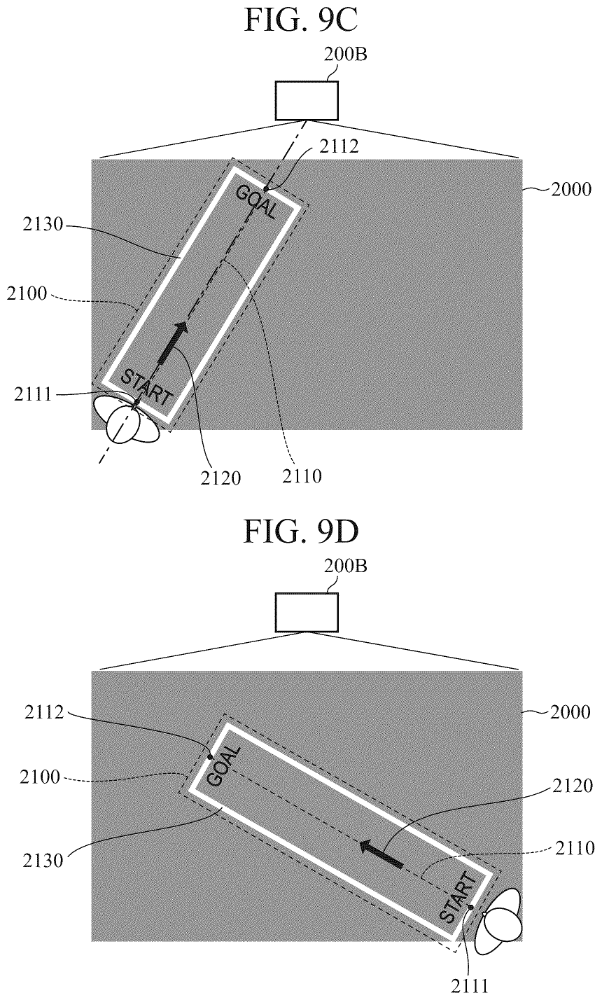

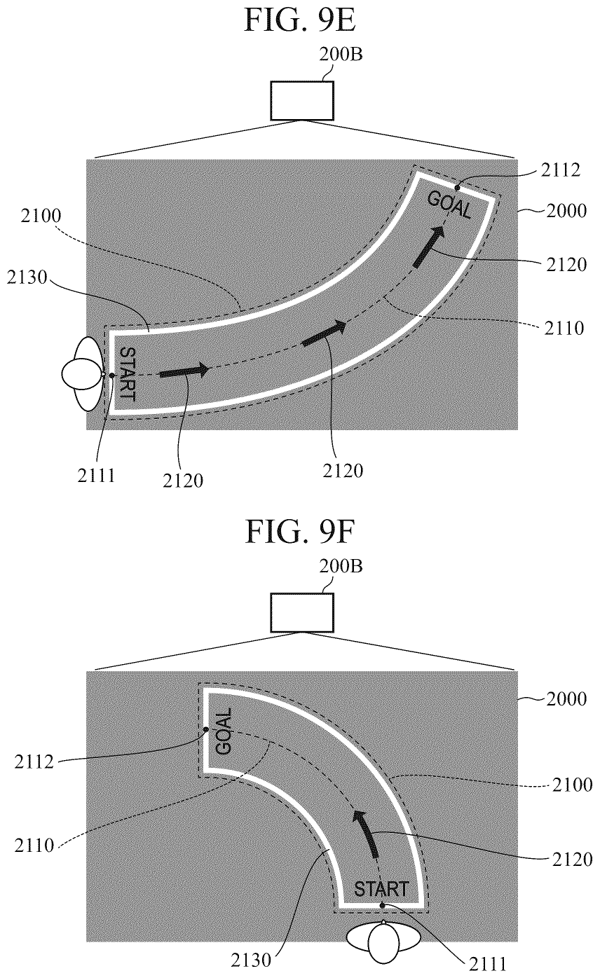

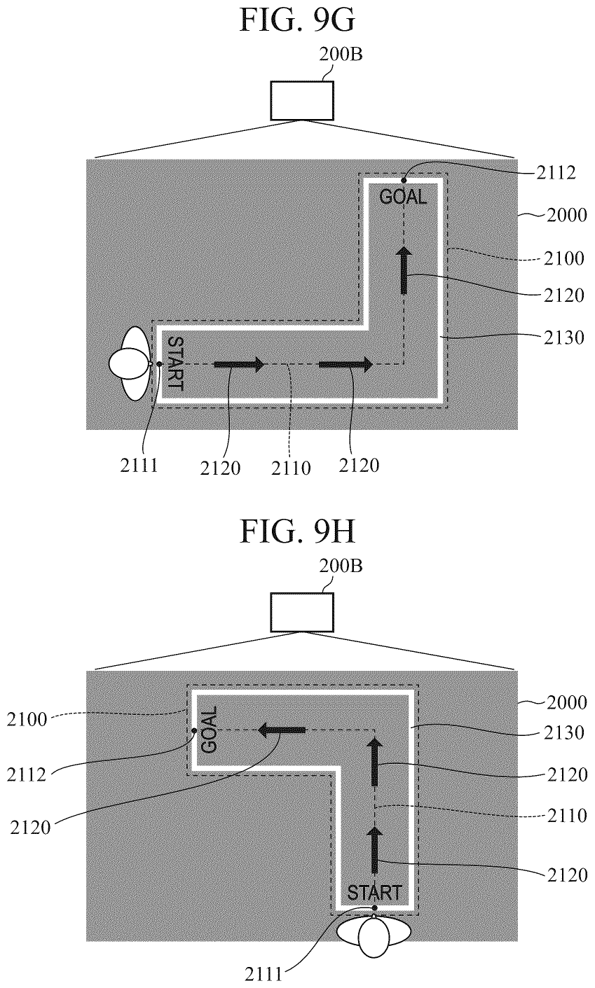

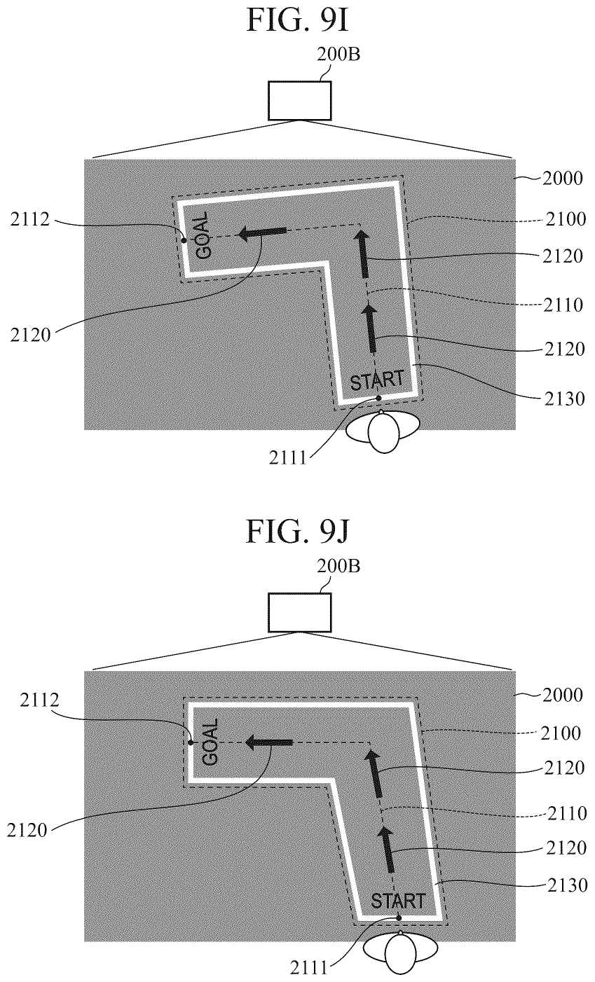

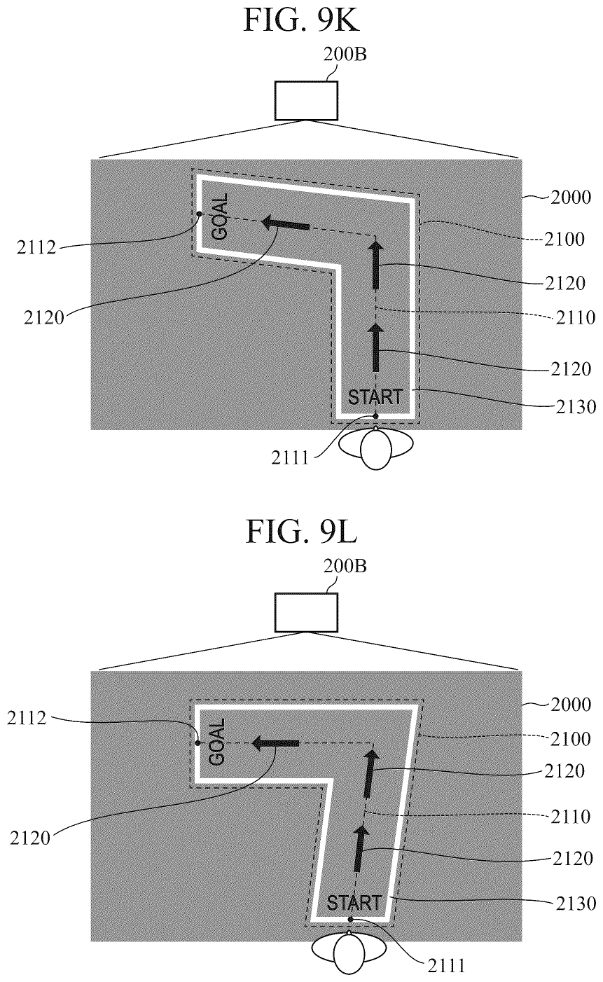

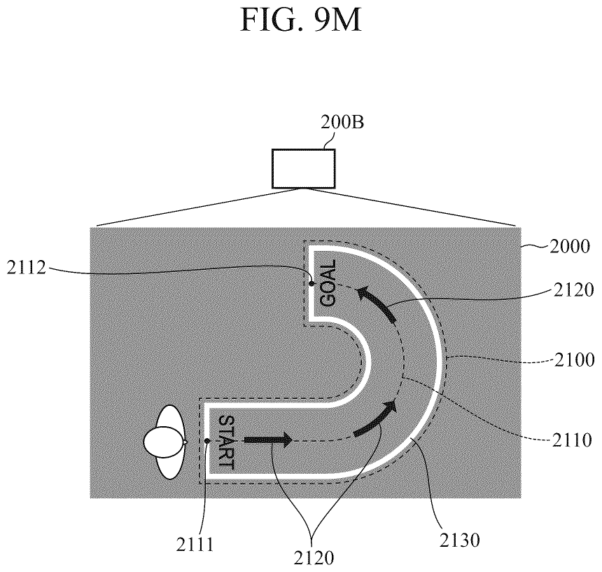

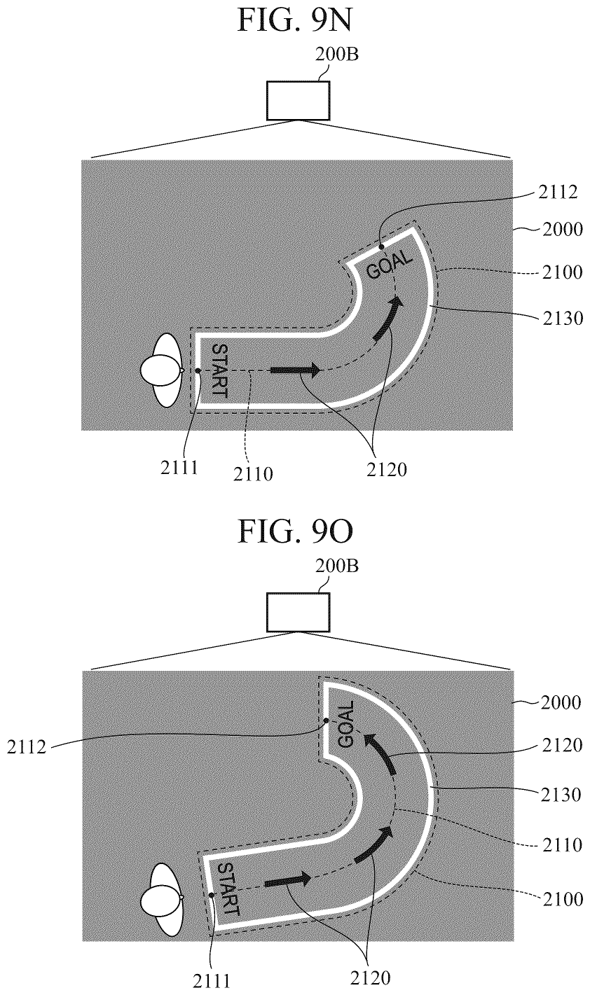

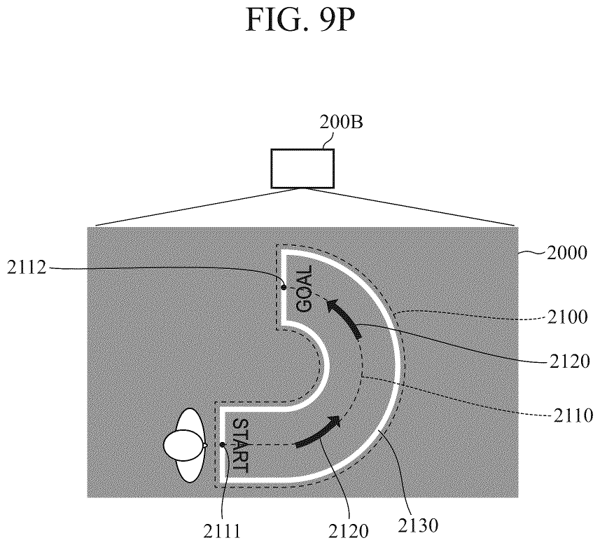

FIGS. 9A, 9B, 9C, 9D, 9E, 9F, 9G, 9H, 9I, 9J, 9K, 9L, 9M, 9N, 9O, and 9P are diagrams for describing concepts of route components used in the information processing device 100B according to the second embodiment of the present disclosure. FIGS. 9A, 9B, 9C, 9D, 9E, 9F, 9G, 9H, 9I, 9J, 9K, 9L, 9M, 9N, 9O, and 9P may be simply referred to as FIG. 9 when collectively described.

FIG. 9 illustrates a projecting device 200B, a projection area 2000, a route component 2100, a route component length 2110, a start point 2111, an end point 2112, a traveling direction 2120, and a route component shape 2130.

The route component 2100 indicates the route component length 2110, the start point 2111, the end point 2112, the traveling direction 2120, and the route component shape 2130. In the description, the content of the route component 2100 is assumed to be stored in a predetermined state, but may be appropriately updated.

The route component 2100 illustrated in FIG. 9 indicates a route pattern in which a shadow due to the presence of the user does not occur.

The route component length 2110 is a length between the start point 2111 and the end point 2112 of the route component 2100.

The traveling direction 2120 indicates a direction to travel from the start point 2111 toward the end point 2112 in the route.

Note that each route component 2100 illustrated in FIG. 9 is a concept and is not illustrated so as to accurately specify the positional relationship and dimensions with respect to the projecting device 200B or the projection area 2000, and the route component 2100 only needs to include information created on the basis of a rule indicating a route pattern in which a shadow due to the presence of the user does not occur.

By generating a route using such a route component 2100, it is possible to suppress the generated route and the mark on the route from being invisible in the shadow of the user.

The route component 2100 illustrated in FIG. 9A indicates a route pattern traveling to the projecting device 200B orthogonal to a side in a direction facing the projecting device 200B in the projection area 2000.

The route component 2100 illustrated in FIG. 9B indicates a route pattern traveling in parallel to the side in the direction facing the projecting device 200B in the projection area 2000.

The route component 2100 illustrated in FIG. 9C indicates a route pattern traveling to the projecting device 200B from a position other than a position facing the projecting device 200B in the projection area 2000.

The route component 2100 illustrated in FIG. 9D indicates a route pattern not traveling orthogonally or parallel to a side facing the projecting device 200B in the projection area 2000. FIG. 9D illustrates a route pattern traveling straight in a direction other than an orthogonal direction and a parallel direction with respect to the side facing the projecting device 200B.

The route component 2100 illustrated in FIG. 9E indicates a route pattern traveling in a direction approaching a diagonal from a position of a corner far from the projecting device 200B in the projection area 2000 in an arc.

The route component 2100 illustrated in FIG. 9F indicates a route pattern traveling in a direction approaching the projecting device 200B from a position far from the projecting device 200B in the projection area 2000 in an arc.

The route component 2100 illustrated in FIG. 9G indicates a route pattern traveling in parallel to the side in the direction facing the projecting device 200B from a position far from the projecting device 200B in the projection area 2000, and then traveling in a direction bent in an L shape in a direction of the projecting device 200B.

The route component 2100 illustrated in FIG. 9H indicates an L-shaped route pattern traveling to the projecting device 200B orthogonal to the side in the direction facing the projecting device 200B in the projection area 2000 and then traveling in parallel to the side in the direction facing the projecting device 200B.

The route component 2100 illustrated in FIG. 9I indicates a route pattern in which the angle of the pattern indicated by the route component 2100 illustrated in FIG. 9H is changed.

The route component 2100 illustrated in FIG. 9J indicates a route pattern in which a connection angle between a route in one traveling direction and a route in the other traveling direction indicated by the route component 2100 illustrated in FIG. 9H is changed. Further, the route component 2100 illustrated in FIG. 9J indicates an L-shaped route pattern traveling toward the projecting device 200B from a direction facing and away from the projecting device 200B in the projection area 2000, and then traveling in parallel to the side in the direction facing the projecting device 200B.

The route component 2100 illustrated in FIG. 9K indicates a route pattern in which a connection angle between a route in one traveling direction and a route in the other traveling direction indicated by the route component 2100 illustrated in FIG. 9H is changed to an obtuse angle. Further, the route component 2100 illustrated in FIG. 9K indicates a route pattern in which the connection angle of the route pattern indicated by the route component 2100 illustrated in FIG. 9J is changed. Further, the route component 2100 indicates a route pattern traveling from a direction facing and away from the projecting device 200B in the projection area 2000 toward a side orthogonal to and facing the side in the direction facing the projecting device 200B, and then bending in an L shape.

The route component 2100 illustrated in FIG. 9L indicates a route pattern in which the connection angle of the route pattern indicated by the route component 2100 illustrated in FIG. 9J is changed to an acute angle.

The route component 2100 illustrated in FIG. 9M indicates a J-shaped route pattern traveling in parallel to a side away in the direction facing the projecting device 200B in the projection area and then traveling in a direction approaching the projecting device 200B in an arc.

The route component 2100 illustrated in FIG. 9N indicates a route pattern obtained by deforming the route component 2100 illustrated in FIG. 9M.

The route component 2100 illustrated in FIG. 9O indicates a route pattern obtained by deforming the route component 2100 illustrated in FIG. 9M.

The route component 2100 illustrated in FIG. 9P indicates a route pattern obtained by deforming the route component 2100 illustrated in FIG. 9M.

An example of a mark used in the information processing device 100B will be described.

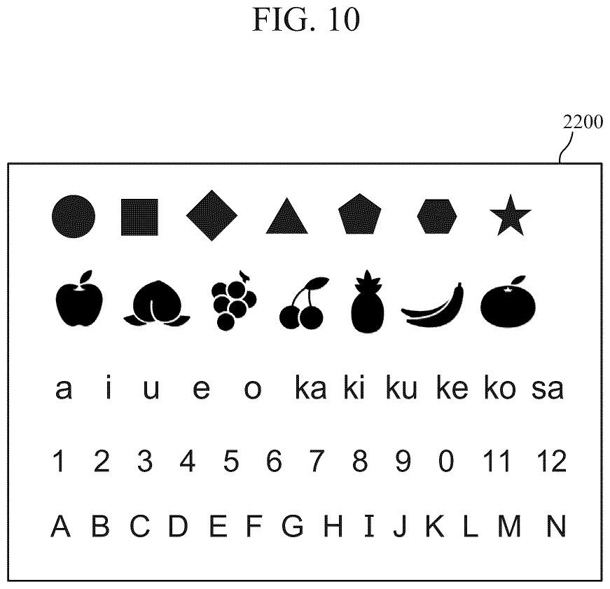

FIG. 10 is a diagram illustrating examples of marks used in the information processing device 100B according to the second embodiment of the present disclosure.

FIG. 10 illustrates marks 2200.

The marks 2200 are of types such as figures or characters.

The figures include a circle, a quadrangle, a triangle, a pentagon, a hexagon, a star, a fruit shape, and the like.

The figures may include a graphic symbol (figure symbol) such as a pictogram although not illustrated.

The characters include hiragana, numbers, alphabetical letters, and the like. Although not illustrated, the characters may include katakana, various numbers, and characters used in each region in the world.

An example of an image generated by the information processing device 100B will be described.

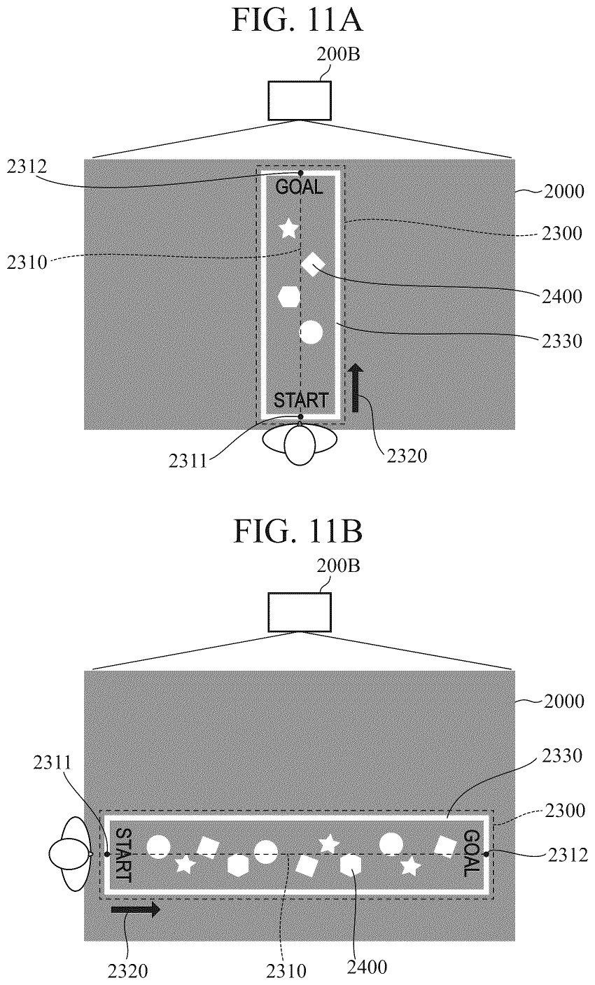

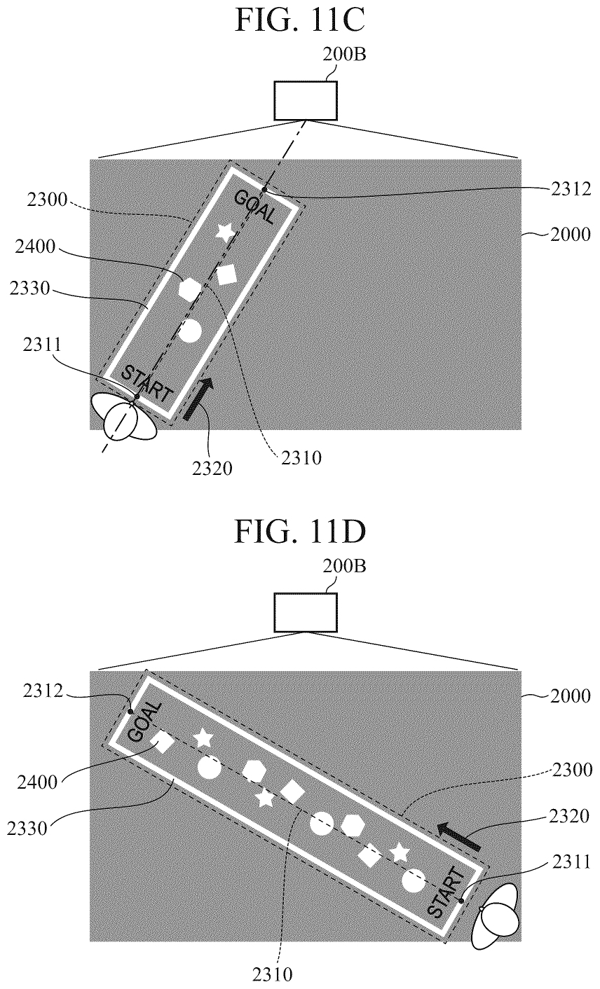

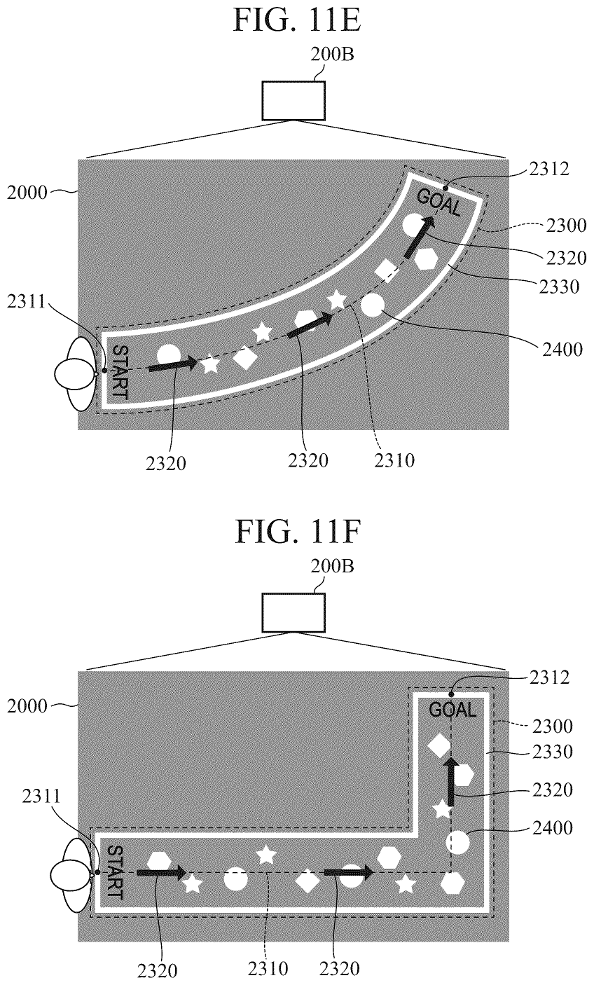

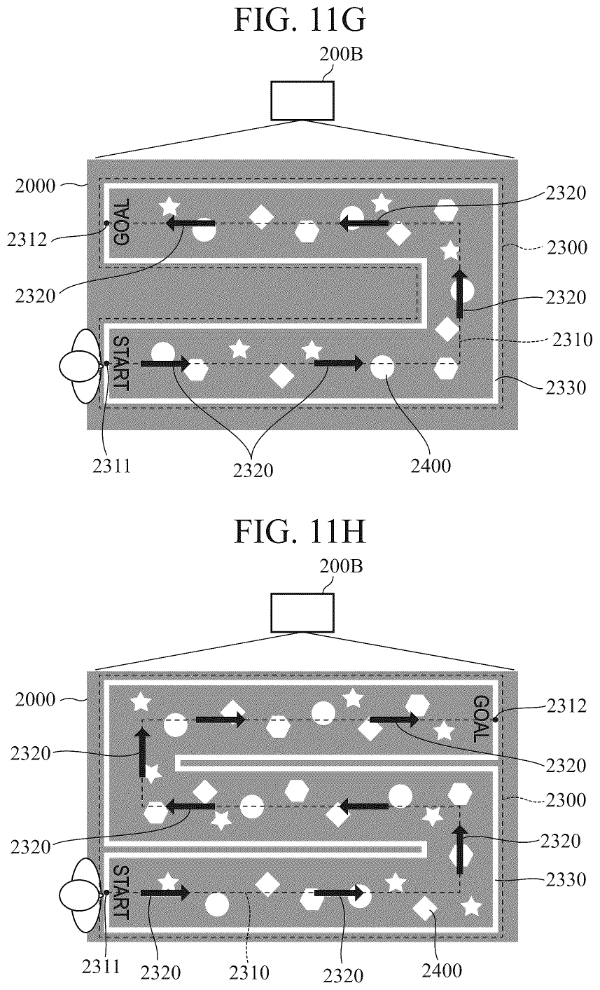

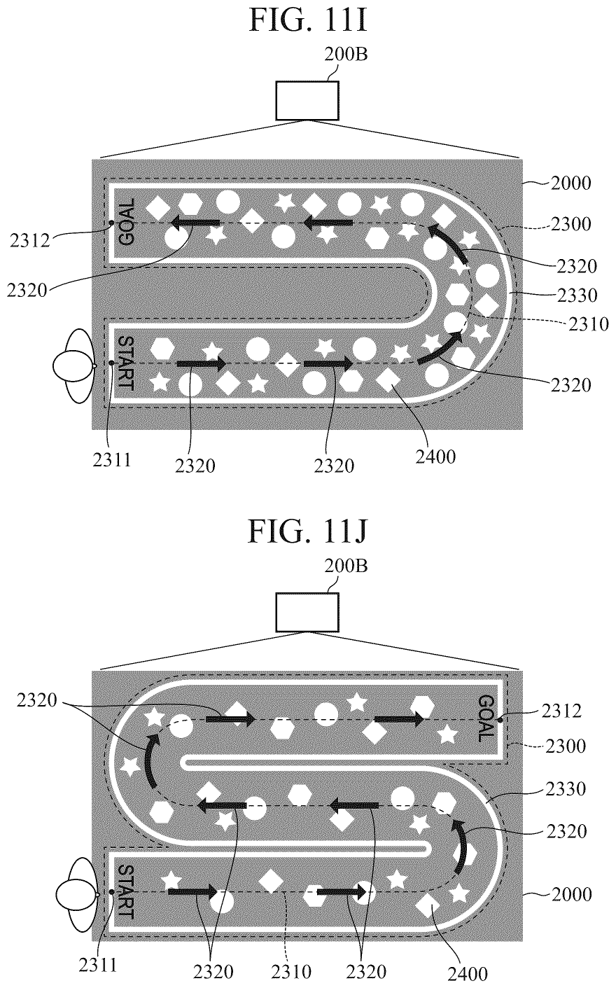

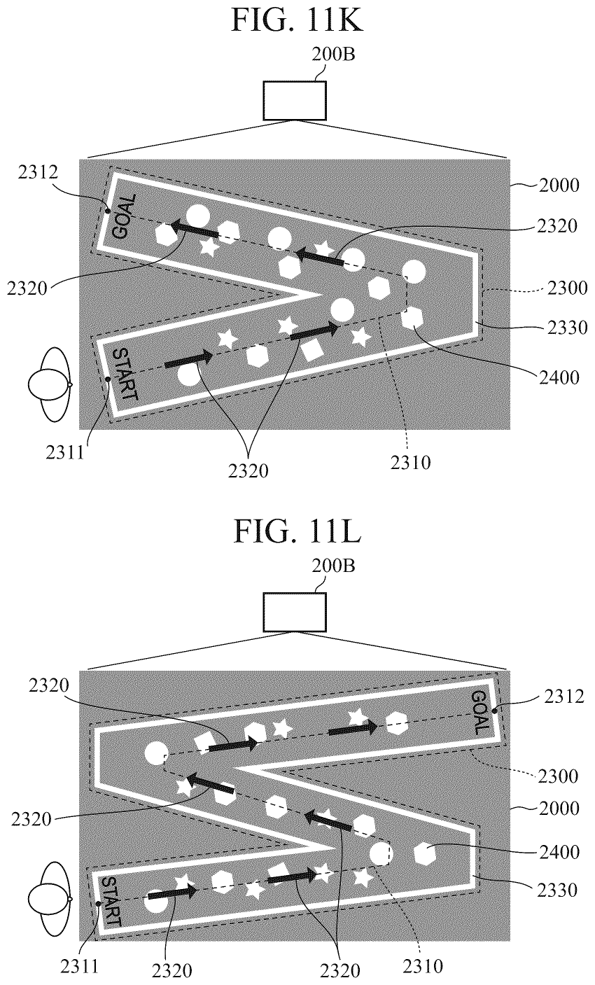

FIGS. 11A, 11B, 11C, 11D, 11E, 11F, 11G, 11H, 11I, 11J, 11K, and 11L are diagrams illustrating examples of an image output by the information processing device 100B according to the second embodiment of the present disclosure or an image projected in the image projecting system 1B. FIGS. 11A, 11B, 11C, 11D, 11E, 11F, 11G, 11H, 11I, 11J, 11K, and 11L may be simply referred to as FIG. 11 when collectively described.

FIG. 11 illustrates the projecting device 200B, the projection area 2000, a route image 2300, a route length 2310, a start position 2311, an end position 2312, a traveling direction 2320, a route shape 2330, and arranged marks 2400.

The route image 2300 indicates a route generated by combining and connecting a plurality of route components 2100 as illustrated in FIG. 9.

The route length 2310 is a length from the start position 2311 to the end position 2312 of the route, and corresponds to a length obtained by combining the route component length 2110 of the route component 2100 used when generating the route so as to satisfy the route condition.

The traveling direction 2320 indicates a direction to travel from the start position 2311 toward the end position 2312 in the route. The traveling direction 2320 need not be included in the image.

The route shape 2330 is a shape determined according to the search condition when included in the search condition.

The arranged marks 2400 are all the marks arranged by the mark arranging unit 142 and displayed on the route along the route. In a case where the route image is, for example, an image for walking training, the arranged marks 2400 are used as a mark for allowing the user to touch with the sole of the foot.

The route image 2300 illustrated in FIG. 11A indicates a route pattern traveling to the projecting device 200B orthogonal to a side facing the projecting device 200B in the projection area 2000.

The route image 2300 illustrated in FIG. 11B indicates a route pattern traveling in parallel to the side facing the projecting device 200B in the projection area 2000 (a route pattern traveling along the side facing projecting device 200B).

The route image 2300 illustrated in FIG. 11C indicates a route pattern traveling in a direction from a position far from the projecting device 200B toward projecting device 200B in the projection area 2000.

The route image 2300 illustrated in FIG. 11D indicates a route pattern not traveling orthogonally or parallel to the side facing the projecting device 200B in the projection area 2000. FIG. 11D illustrates a route pattern traveling straight in a direction other than an orthogonal direction and a parallel direction with respect to the side facing the projecting device 200B.

The route image 2300 illustrated in FIG. 11E indicates a route pattern traveling in a diagonal direction so as to draw an arc from a corner portion away from the projecting device 200B in the projection area 2000.

The route image 2300 illustrated in FIG. 11F indicates a route pattern traveling along a side present at a position far from the projecting device 200B and facing the projecting device 200B in the projection area 2000, and then traveling while being bent toward the projecting device 200B.

The route image 2300 illustrated in FIG. 11G indicates a concave route pattern that travels along a side present at a position far from the projecting device 200B and facing the projecting device 200B, then traveling while being bent toward the projecting device 200B, and further traveling along a side present at a position facing the projecting device 200B while being bent in the projection area 2000.

The route image 2300 illustrated in FIG. 11H indicates a route pattern traveling in a direction approaching the projecting device 200B so as to draw an S-shape with a position far from the projecting device 200B as a start position in the projection area 2000.

The route image 2300 illustrated in FIG. 11I indicates a route pattern traveling along a side present at a position facing the projecting device 200B with a position far from the projecting device 200B as a start position, and traveling in a direction approaching the projecting device 200B so as to draw a U shape in the projection area 2000.

The route image 2300 illustrated in FIG. 11J indicates a route pattern traveling so as to draw an inverted S shape with a position far from the projecting device 200B as a start position, and traveling in a direction approaching the projecting device 200B in the projection area 2000.

The route image 2300 illustrated in FIG. 11K indicates a route pattern traveling with a position far from the projecting device 200B as a start position, traveling in a direction in which the side present at the position facing the projecting device 200B extends, and then traveling in a direction approaching the projecting device 200B so as to draw a V shape by bending in the projection area 2000.

The route image 2300 illustrated in FIG. 11L indicates a route pattern traveling with a position far from the projecting device 200B as a start position, traveling in a direction in which the side present at the position facing the projecting device 200B extends, and traveling in a direction approaching the projecting device 200B so as to draw an inverted Z shape in the projection area 2000.

The information processing device of the present disclosure is further configured as follows.

“The information processing device, in which
the route generating unit acquires the route component indicating a route pattern in which a shadow due to presence of a user does not occur.”

Thus, the present disclosure further has an effect that it is possible to provide an information processing device that generates a route in which a shadow due to the presence of the user does not occur with respect to the image projected on the projection area. Further, the present disclosure further has an effect that it is possible to provide an information processing device that outputs an image in which a projected mark is not hidden by the shadow of the user with respect to the image projected on the projection area.

Furthermore, the present disclosure has an effect similar to the above effect by applying the above configuration to the above information processing method or the above image projecting system.

The information processing device of the present disclosure is further configured as follows.

“The information processing device, in which
the route condition includes:
a scheduled length that is a length of a route to be projected on an area indicated in the area information;
a start position of a route to be projected on an area indicated in the area information; or
a number of direction changes of a route to be projected on an area indicated in the area information.”

Thus, the present disclosure has an effect that it is possible to further provide an information processing device capable of generating an image indicating a route suitable for the user with respect to the image projected on the projection area.

Furthermore, the present disclosure has an effect similar to the above effect by applying the above configuration to the above information processing method or the above image projecting system.

The information processing device of the present disclosure is further configured as follows.

“The information processing device, in which the mark condition includes identification information of a mark and an arrangement interval of each of marks.”

Thus, the present disclosure has an effect that it is possible to further provide an information processing device capable of generating an image indicating marks of types and at arrangement intervals suitable for the user with respect to the image projected on the projection area.

Furthermore, the present disclosure has an effect similar to the above effect by applying the above configuration to the above information processing method or the above image projecting system.

### Third Embodiment

The third embodiment is an embodiment in which a mark is not arranged in an area where a shadow will occur when the user is present in the generated route.

In the description of the third embodiment, the description of the configuration described in the first embodiment or the configuration described in the second embodiment may be appropriately omitted.

A detailed configuration example of an information processing device 100C and an image projecting system 1C including the information processing device 100C will be described.

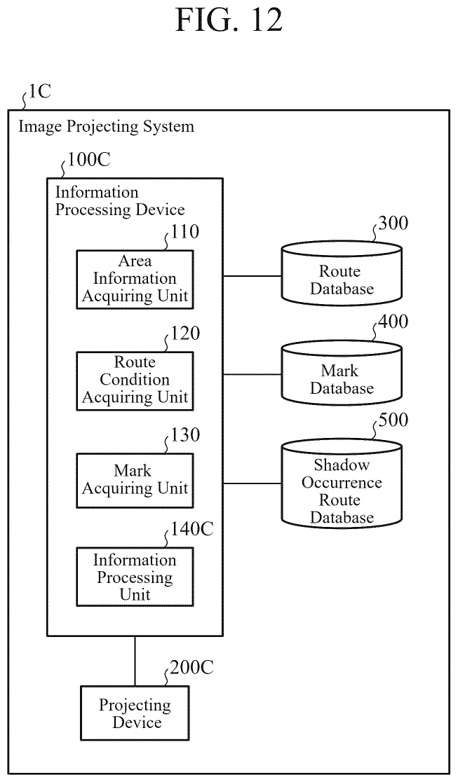

FIG. 12 is a diagram illustrating a configuration example of the information processing device 100C and the image projecting system 1C according to the third embodiment of the present disclosure.

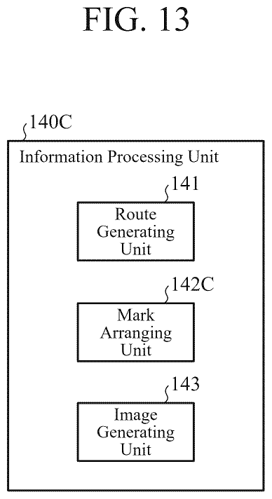

FIG. 13 is a diagram illustrating a configuration example of an information processing unit 140C in the information processing device 100C according to the third embodiment of the present disclosure.

The image projecting system 1C illustrated in FIG. 12 includes the information processing device 100C, a projecting device 200C, a route database 300, a mark database 400, and a shadow occurrence route database 500.

The information processing device 100C includes an area information acquiring unit 110, a route condition acquiring unit 120, a mark acquiring unit 130, and an information processing unit 140C.

The information processing device 100C includes a control unit which is not illustrated, a storage unit which is not illustrated, and a communication unit which is not illustrated as components to be mounted on a general computer.

The area information acquiring unit 110 acquires area information regarding the projection area of the projecting device 200C similarly to the area information acquiring unit 110 described above.

The area information acquiring unit 110 acquires, for example, area information regarding the projection area of the projecting device 200C stored in advance. In this case, the area information is stored in advance in the projecting device 200C, the information processing device 100C, or the image projecting system 1C.

Alternatively, the area information acquiring unit 110 acquires, for example, area information input to the information processing device 100C by an operator of the information processing device 100C.

The route condition acquiring unit 120 acquires a route condition of a route to be projected on the area indicated by the area information, similarly to the route condition acquiring unit 120 described above. The route condition acquired by the route condition acquiring unit 120 includes at least one of a start position, a scheduled length, or the number of direction changes.

The start position included in the route condition is a position at which the route to be projected on the area indicated by the area information starts.

The scheduled length included in the route condition is the length of the route to be projected on the area indicated by the area information.

The number of direction changes included in the route condition is the number of changes in the traveling direction in the route to be projected on the area indicated by the area information.

The route condition may further include a shape of the route component and an end position.

The shape of the route component that can be included in the route condition is, for example, a shape such as a straight line shape, a C shape, an I shape, a J shape, an L shape, an M shape, an N shape, and an S shape.

Similarly to the mark acquiring unit 130 described above, the mark acquiring unit 130 acquires a mark condition related to a mark to be projected on the area indicated by the area information.

The mark included in the mark condition is one type of mark or a plurality of types of marks.

The mark condition includes identification information of the mark and an arrangement interval of each mark.

The information processing unit 140C generates and outputs an image in which marks satisfying the mark condition are arranged along a route satisfying the route condition in the projection area.

The information processing unit 140C generates and outputs an image in which marks are arranged so as to satisfy the mark condition in an area other than an area where a shadow due to a user occurs when the user is present in the projection area along a route satisfying the route condition in the projection area.

The information processing unit 140C illustrated in FIG. 13 includes a route generating unit 141, a mark arranging unit 142C, and an image generating unit 143.

The route generating unit 141 generates a route satisfying the route condition in the projection area.

Specifically, the route generating unit 141 acquires route components from route components stored in advance so as to satisfy the route condition in the range of the projection area indicated by the area information, and connects the route components to generate a route.

More specifically, the route generating unit 141 acquires the area information and the route condition, refers to the route database 300 using the area information and the route condition, and acquires the route component from among the route components stored in the route database 300 so as to satisfy the route condition in the range of the projection area indicated by the area information. The route generating unit 141 generates a route by combining the acquired route components and connecting routes in the route components. The route generating unit 141 outputs route information indicating the generated route.

The mark arranging unit 142C arranges marks along the route generated by the route generating unit 141.

Specifically, for example, the mark arranging unit 142C acquires mark information satisfying the mark condition from the mark information stored in advance, and arranges a mark along the route generated by the route generating unit 141 using the mark information. A single or a plurality of marks is arranged. Further, there are one type or a plurality of types of marks to be arranged.

More specifically, the mark arranging unit 142C acquires the mark condition, refers to the mark database 400 using the mark condition, and acquires the mark information satisfying the mark condition. The mark arranging unit 142C arranges the mark along the route generated by the route generating unit 141 using the acquired mark information.

Further, when arranging the mark, the mark arranging unit 142C arranges the mark on a route where no shadow occurs in the route.

Specifically, the mark arranging unit 142C refers to the shadow occurrence route database 500 using, for example, route information indicating a route generated by the route generating unit 141, and arranges the mark in the route other than a shadow occurrence route in which a shadow occurs.

More specifically, for example, the mark arranging unit 142C acquires a shadow occurrence route indicating a route pattern in which a shadow due to the presence of the user occurs, and arranges the mark along a route other than the route pattern of the shadow occurrence route among routes generated by the route generating unit 141.

The mark arranging unit 142C outputs arranged mark information indicating all the arranged marks.

The image generating unit 143 outputs an image including the mark arranged by the mark arranging unit 142C.

Specifically, for example, the image generating unit 143 superimposes and outputs an image indicating the route generated by the route generating unit 141 and an image indicating the mark arranged by the mark arranging unit 142C.

More specifically, the image generating unit 143 acquires the route information indicating the route generated by the route generating unit 141, and acquires the arranged mark information indicating all the arranged marks arranged by the mark arranging unit 142C. The image generating unit 143 generates a route image indicating the route using the route information. The image generating unit 143 generates an arranged mark image indicating arranged marks arranged according to the projection area using the arranged mark information. The image generating unit 143 outputs a projection image, which is an image obtained by superimposing the route image and the arranged mark image, to the projecting device 200D.

The projecting device 200C has functions similar to those of the projecting devices 200A and 200B described above. The projecting device 200C illustrated in FIG. 12 receives an image generated and output by the image generating unit 143 in the information processing unit 140C of the information processing device 100C, and projects the received image by outputting the received image to a projection target such as a floor surface.

The route database 300 stores route component information regarding route components.

Specifically, the route database 300 includes information regarding route components with which an image of a continuous route can be generated in the projection area by connecting a plurality of route components such as a start point of a route in route components, an end point of the route in the route components, a length of the route in the route components, a shape of the route in the route components, and the number of direction changes of the route in the route components, and stores the information as the route component information in association with each other.

The start point of a route and the end point of the route are, for example, information indicated by coordinates of the start point and coordinates of the end point with respect to a reference point in a route component image.

The length of the route is a length along a route from the start point to the end point in the route component image.

The shape of the route is, for example, information indicated in the form of a coordinate group indicating a boundary that separates the route and the rest in the route component image. Alternatively, for example, the image itself indicating the shape of the route in the route component may be used.

The number of direction changes of the route is information indicating the number of direction changes along the route in the route component image. For example, when the route is straight, the number of direction changes is “0”, and when the route is L-shaped, the number of direction changes is “1”. Note that, in a case where the route draws a curve, the number of direction changes may be “1” from the start point to the end point of the curve in the route, or the number of changes in direction per fixed length.

Note that, although a mode in which a route component stored in the route database 300 provided outside the information processing device 100C is used will be described here, the route database 300 may be included inside the information processing device 100C.

The mark database 400 stores mark information for each mark type for a plurality of types of marks.

Specifically, the mark database 400 stores the mark identification information and the mark image in association with each other.

The types of marks include figures, characters, and the like.

The figure includes a circle, a triangle, a quadrangle, a hexagon, a star, a fruit shape, and the like.

The characters include hiragana, katakana, various numbers, and characters used in each region in the world.

Note that, here, a mode in which marks stored in the mark database 400 provided outside the information processing device 100C are used will be described, but the mark database 400 may be included inside the information processing device 100C.

The shadow occurrence route database 500 stores a shadow occurrence route.

The shadow occurrence route indicates a route pattern in which a shadow due to the presence of the user occurs.

Specifically, the shadow occurrence route database 500 stores shadow occurrence route information indicating a route pattern of the shadow occurrence route. The shadow occurrence route information is information such as a start point of the shadow occurrence route in shadow occurrence route components, an end point of the shadow occurrence route in the shadow occurrence route components, a traveling direction of the shadow occurrence route in the shadow occurrence route components, a length of the shadow occurrence route in the shadow occurrence route components, and a shape of the shadow occurrence route in the shadow occurrence route components, similarly to the form of the information regarding the route component in the route database. Further, the shadow occurrence route information may include a position where a shadow of the user is likely to be generated for each position in the projection area using the relationship between the position of the projecting device 200C and the projection area. Thus, a mark can be arranged on a route pattern in which a shadow does not occur depending on the position of the route in the projection area among the route patterns indicated by the shadow occurrence route.

Note that, here, a form using the shadow occurrence route stored in the shadow occurrence route database 500 provided outside the information processing device 100C will be described, and thus the shadow occurrence route database 500 may be included inside the information processing device 100C.

The processing of the information processing device 100C is different in processing content of the mark arrangement processing out of the processing of the information processing devices 100, 100A, and 100B described above. In particular, only the processing content of the mark arrangement processing is different from the processing of the information processing device 100A. Therefore, the mark arrangement processing will be described for the processing of the information processing device 100C, and description of processing other than the mark arrangement processing will be omitted.

An example of mark arrangement processing in the processing of the information processing device 100C will be described. Further, an example of an image output as a result of the processing of the information processing device 100C will be described.

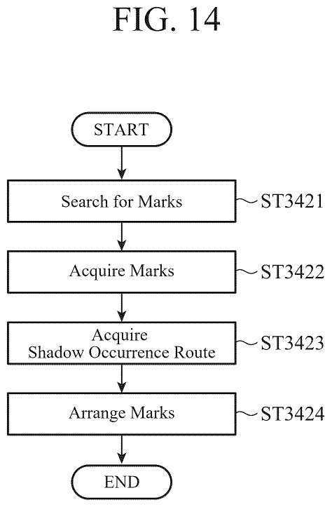

FIG. 14 is a flowchart illustrating an example of mark arrangement processing in processing of the information processing device 100C according to the third embodiment of the present disclosure.

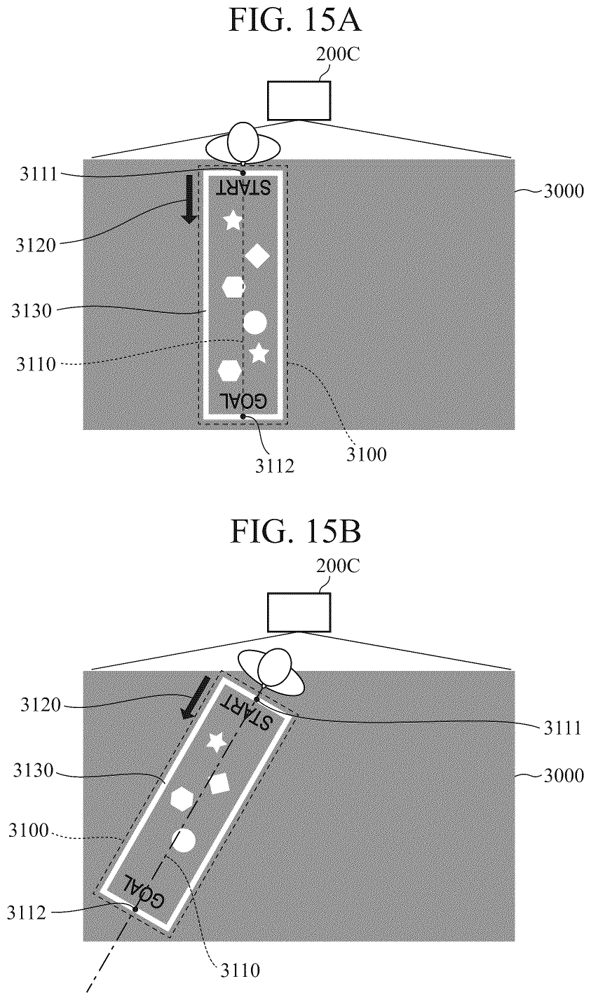

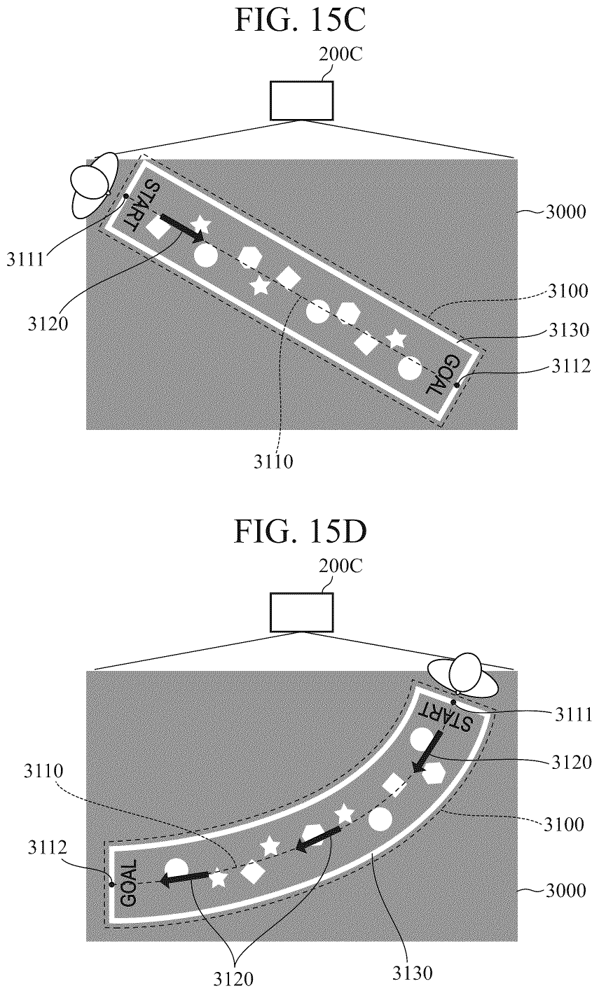

FIGS. 15A, 15B, 15C, and 15D are diagrams for describing concepts of the shadow occurrence route used in the information processing device 100C according to the third embodiment of the present disclosure. FIGS. 15A, 15B, 15C, and 15D may be simply referred to as FIG. 15 when collectively described.

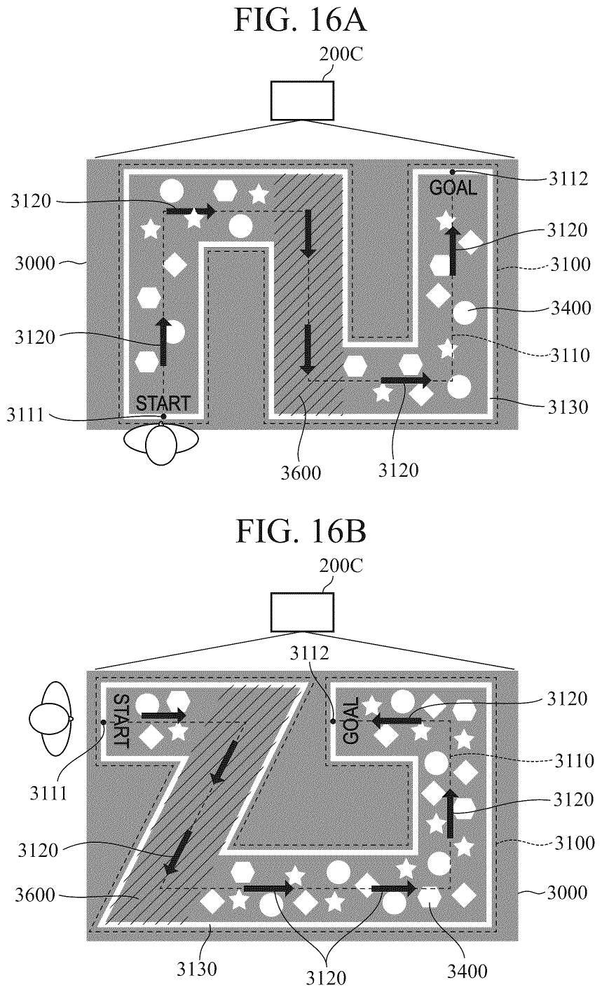

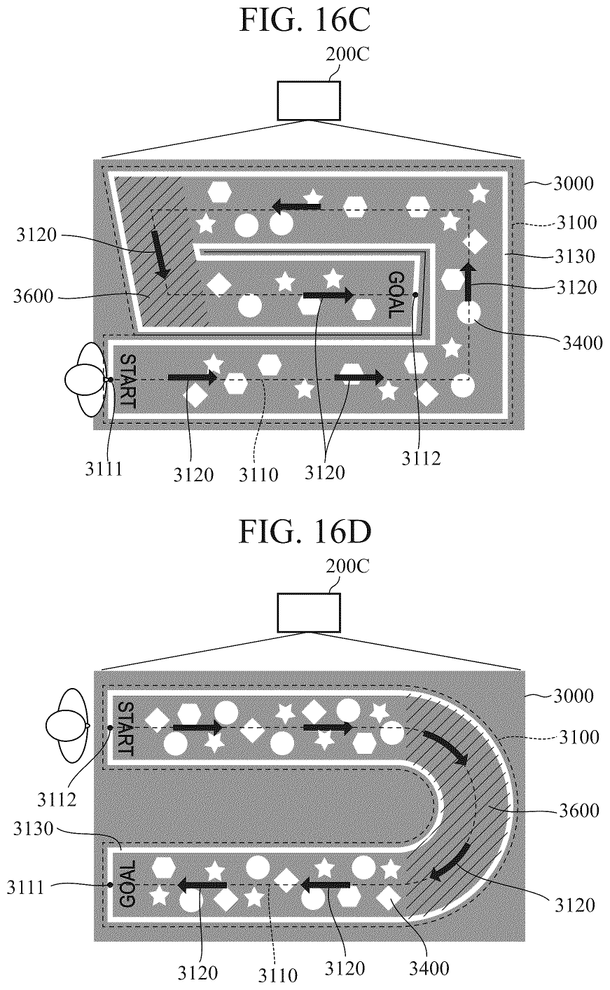

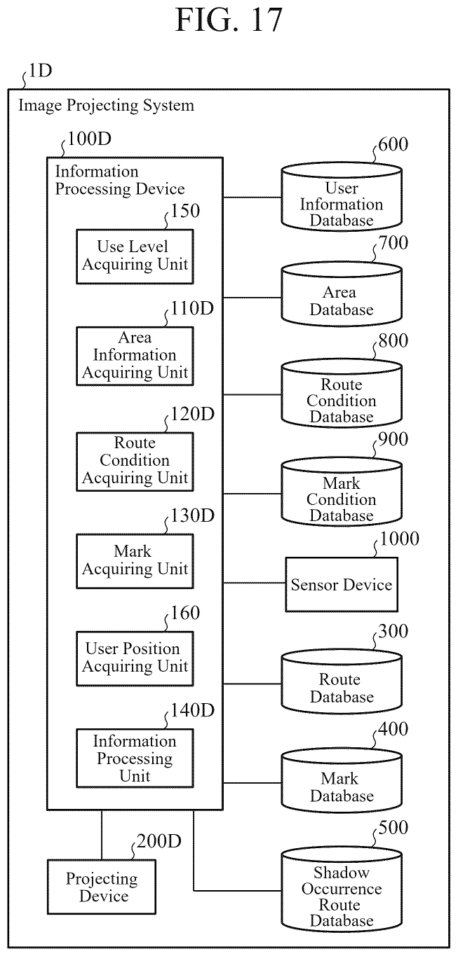

FIGS. 16A, 16B, 16C, and 16D are diagrams illustrating examples of the concept output by the information processing device 100C according to the third embodiment of the present disclosure or a concept projected in the concept projecting system 1C. FIGS. 16A, 16B, 16C, and 16D may be simply referred to as FIG. 16 when collectively described.

The information processing unit 140C of the information processing device 100C executes the mark arrangement processing illustrated in FIG. 14 in the concept generation output processing.

In the mark arrangement processing, the mark arranging unit 142C of the information processing unit 140C first executes mark search processing (step ST3421). The mark arranging unit 142C searches the mark information satisfying the mark condition from the mark information stored in advance. Specifically, upon receiving the mark condition from the mark acquiring unit 130, the mark arranging unit 142C refers to the mark database 400 using the mark condition and searches for mark information satisfying the mark condition.

Next, the mark arranging unit 142C executes mark acquisition processing of acquiring the mark information as a search result (step ST3422).

Next, the mark arranging unit 142C executes shadow occurrence route acquisition processing (step ST3423). The shadow occurrence route acquisition processing is executed. Specifically, the mark arranging unit 142C refers to the shadow occurrence route database 500 using the route information indicating the route generated by the route generating unit 141, and acquires a shadow occurrence route indicating a route pattern in which a shadow occurs due to the presence of the user.

The shadow occurrence route is a concept illustrated in FIG. 15. A concept of the shadow occurrence route will be described later.

Next, the mark arranging unit 142C executes the mark arrangement processing (step ST3424). The mark arranging unit 142C arranges the mark so as to avoid a shadow occurrence route in which a shadow may occur in the route. Specifically, the mark arranging unit 142C arranges the mark along a route other than the route pattern of the shadow occurrence route among the routes generated by the route generating unit 141 using the shadow occurrence route. The mark arranging unit 142C outputs arranged mark information indicating all the arranged marks.

With such processing, an image projected as illustrated in FIG. 16 can be output.

An example of concepts of a shadow occurrence route used in the information processing device 100C and a shadow occurrence route stored in the shadow occurrence route database 500 will be described.

FIG. 15 illustrates the projecting device 200C, a projection area 3000, a shadow occurrence route component 3100, a shadow occurrence route component length 3110, a start point 3111, an end point 3112, a traveling direction 3120, and a shadow occurrence route shape 3130.

The shadow occurrence route component 3100 illustrated in FIG. 15 indicates a route pattern in which a shadow due to the user occurs when the user is present.

The shadow occurrence route component 3100 indicates the shadow occurrence route component length 3110, the start point 3111, the end point 3112, the traveling direction 3120, and the shadow occurrence route shape 3130.

The shadow occurrence route component length 3110 is a length from the start point 3111 to the end point 3112 in the shadow occurrence route component 3100.

The traveling direction 3120 indicates a direction to travel from the start point 3111 toward the end point 3112 in the shadow occurrence route component 3100.

The shadow occurrence route shape 3130 indicates the shape of the shadow occurrence route component 3100.

In the description, the content of the shadow occurrence route component 3100 is assumed to be stored in a predetermined state, but may be appropriately updated.

Note that the shadow occurrence route component 3100 illustrated in FIG. 15 is a concept, and is not illustrated so as to accurately specify the positional relationship and the dimensions with respect to the projecting device 200C or the projection area 3000, and the shadow occurrence route component 3100 only needs to include information created on the basis of a rule indicating a route pattern in which a shadow due to the presence of the user occurs.

The shadow occurrence route component 3100 illustrated in FIG. 15A indicates a route pattern traveling from a position close to the projecting device 200C toward a position far therefrom orthogonal to a side in a direction facing the projecting device 200C in the projection area 3000.

The shadow occurrence route component 3100 illustrated in FIG. 15B indicates a route pattern traveling from a position close to the projecting device 200C toward a far corner in the projection area 3000.

The shadow occurrence route component 3100 illustrated in FIG. 15C indicates a route pattern traveling from a corner portion close to the projecting device 200C toward a corner portion having a diagonal relationship in the projection area 3000.

The shadow occurrence route component 3100 illustrated in FIG. 15D indicates a route pattern traveling from a corner portion close to the projecting device 200C toward a corner portion having a diagonal relationship so as to draw an arc in the projection area 3000.

An example of a concept generated by the information processing device 100C will be described.

FIG. 16 illustrates the projecting device 200C, the projection area 3000, a route image 3300, a route length 3310, a start position 3311, an end position 3312, a route shape 3330, arranged marks 3400, and a shadow occurrence route 3600.

The route image 3300 indicates a route generated by combining and connecting a plurality of route components 2100 as illustrated in FIG. 9 described above.

The route length 3310 is a length from the start position 3311 to the end position 3312 of the route, and corresponds to a length obtained by combining the route component lengths 2110 of the route components 2100 used when generating the route so as to satisfy the route condition.

The traveling direction 3320 indicates a direction to travel from the start position 3311 toward the end position 3312 in the route. The traveling direction 3320 need not be included in the image.

The route shape 3330 is a shape determined according to the search condition when the route shape 3330 is included in the search condition.

The arranged marks 3400 are all the marks arranged by the mark arranging unit 142C and displayed on the route along the route. In a case where the route image is, for example, an image for walking training, the arranged marks 3400 are used as a mark for allowing the user to touch with the sole of the foot.

The arranged marks 3400 are arranged avoiding the shadow occurrence route 3600 in the route indicated by the route image 3300.

The shadow occurrence route 3600 collates whether the route of the route image 3300 corresponds to the shadow occurrence route component 3100 as illustrated in FIG. 15, and indicates an area corresponding to the shadow occurrence route component 3100 in the route of the route image 3300.

In the route image 3300 illustrated in FIG. 16A, although the shadow occurrence route 3600 is included, the marks are arranged only in the route other than the shadow occurrence route 3600, and the arranged marks 3400 are not invisible due to the user's shadow.

In the route image 3300 illustrated in FIG. 16B, although the shadow occurrence route 3600 is included, the marks are arranged only in the route other than the shadow occurrence route 3600, and the arranged marks 3400 are not invisible due to the user's shadow.

In the route image 3300 illustrated in FIG. 16C, although the shadow occurrence route 3600 is included, the marks are arranged only in the route other than the shadow occurrence route 3600, and the arranged marks 3400 are not invisible due to the user's shadow.

In the route image 3300 illustrated in FIG. 16D, although the shadow occurrence route 3600 is included, the marks are arranged only in the route other than the shadow occurrence route 3600, and the arranged marks 3400 are not invisible due to the user's shadow.

The information processing device of the present disclosure is further configured as follows.

“The information processing device, in which
the mark arranging unit acquires a shadow occurrence route indicating a route pattern in which a shadow due to presence of a user occurs, and arranges the mark along the route other than the route pattern of the shadow occurrence route among routes generated by the route generating unit.”

Thus, the present disclosure further has an effect that it is possible to provide an information processing device that prevents a mark from being arranged on a route where a shadow due to the presence of the user occurs with respect to the image projected on the projection area. Further, the present disclosure further has an effect that it is possible to provide an information processing device that outputs an image in which a projected mark is not hidden by the shadow of the user with respect to the image projected on the projection area.

Furthermore, the present disclosure has an effect similar to the above effect by applying the above configuration to the above information processing method or the above image projecting system.

The information processing device of the present disclosure is further configured as follows.

“The information processing device, in which
the route condition includes:
a scheduled length that is a length of a route to be projected on an area indicated in the area information;
a start position of a route to be projected on an area indicated in the area information; or
a number of direction changes of a route to be projected on an area indicated in the area information.”

Thus, the present disclosure has an effect that it is possible to further provide an information processing device capable of generating an image indicating a route suitable for the user with respect to the image projected on the projection area.

Furthermore, the present disclosure has an effect similar to the above effect by applying the above configuration to the above information processing method or the above image projecting system.

The information processing device of the present disclosure is further configured as follows.

“The information processing device, in which the mark condition includes identification information of a mark and an arrangement interval of each of marks.”

Thus, the present disclosure has an effect that it is possible to further provide an information processing device capable of generating an image indicating marks of types and at arrangement intervals suitable for the user with respect to the image projected on the projection area.

Furthermore, the present disclosure has an effect similar to the above effect by applying the above configuration to the above information processing method or the above image projecting system.

### Fourth Embodiment

The fourth embodiment is an embodiment in which an information processing device performs processing of generating an image corresponding to a user who uses the image.

In the description of the fourth embodiment, the description of the configuration described in the first embodiment, the configuration described in the second embodiment, or the configuration described in the third embodiment may be appropriately omitted.

A detailed configuration example of an information processing device 100D and an image projecting system 1D including the information processing device 100D will be described.

FIG. 17 is a diagram illustrating a configuration example of the information processing device 100D and the image projecting system 1D according to the fourth embodiment of the present disclosure.

The image projecting system 1D illustrated in FIG. 17 includes the information processing device 100D, a projecting device 200D, a route database 300, a mark database 400, a shadow occurrence route database 500, a user information database 600, an area database 700, a route condition database 800, a mark condition database 900, and a sensor device 1000.

The information processing device 100D includes an area information acquiring unit 110D, a route condition acquiring unit 120D, a mark acquiring unit 130D, an information processing unit 140D, a use level acquiring unit 150, and a user position acquiring unit 160.

The use level acquiring unit 150 acquires a use level for each user.

Specifically, upon receiving user identification information for identifying the user, the use level acquiring unit 150 refers to the user information database 600 using the user identification information to acquire the use level.

For example, in a case where a user who uses an image projected from the information processing device 100D via the projecting device 200D is a subject of walking training (rehabilitation), the use level indicates the degree of walking ability. In this case, the user identification information is input to the information processing device 100D by, for example, a person in charge of assisting rehabilitation. Further, the user identification information may be input by the subject of the walking training.

The use level is used to acquire area information indicating an area having a size corresponding to the use level.

The use level is used to acquire a route condition indicating a route according to the use level.

The use level is used to acquire a mark condition indicating the type of mark, the number of types of marks, the arrangement interval of marks, or a combination thereof according to the use level.

The user position acquiring unit 160 acquires user position information indicating the position of the user on the basis of a sensor signal.

Specifically, the user position acquiring unit 160 acquires the sensor signal from the sensor device 1000, and detects the position of the user using the acquired sensor signal, thereby acquiring the user position information indicating the position of the user, and outputting the user position information.

The area information acquiring unit 110D acquires area information regarding the projection area of the projecting device 200D.

The area information acquiring unit 110D acquires, for example, area information regarding the projection area of the projecting device 200D stored in advance. In this case, the area information is stored in advance in the projecting device 200D, the information processing device 100D, or the image projecting system 1D.

Alternatively, the area information acquiring unit 110D acquires, for example, area information input to the information processing device 100D by the operator of the information processing device 100D.

Alternatively, the area information acquiring unit 110D acquires the area information using, for example, the use level. Specifically, the area information acquiring unit 110D refers to the area database 700 using the use level to acquire the area information.

Note that in a case where the area information acquiring unit 110D in the information processing device 100D only needs to have the function of the area information acquiring unit 110 described above, the area information acquiring unit may be replaced with the area information acquiring unit described above.

The route condition acquiring unit 120D acquires a route condition of a route to be projected on an area indicated by the area information. The route condition acquired by the route condition acquiring unit 120D includes at least one of a start position, a scheduled length, or the number of direction changes.

The start position included in the route condition is a position at which the route to be projected on the area indicated by the area information starts.

The scheduled length included in the route condition is the length of the route to be projected on the area indicated by the area information.

The number of direction changes included in the route condition is the number of changes in the traveling direction in the route to be projected on the area indicated by the area information.

The route condition may further include a shape of the route component and an end position.

The shape of the route component that can be included in the route condition is, for example, a shape such as a straight line shape, a C shape, an I shape, a J shape, an L shape, an M shape, an N shape, and an S shape.

The route condition acquiring unit 120D acquires the route condition using the user position or the use level.

Alternatively, the route condition acquiring unit 120D acquires the route condition using the user position and the use level.

When the route condition acquiring unit 120D acquires the route condition using the user position, the route condition acquiring unit 120D acquires the start position of the route in the projection area using, for example, the user position information. Specifically, the route condition acquiring unit 120D determines the position in the projection area closest to the position of the user using the position indicated by the user position information and the projection area indicated by the area information, and acquires the start position.

When the route condition acquiring unit 120D acquires the route condition using the use level, the route condition acquiring unit 120D refers to the route condition database 800 using the use level, for example, and acquires the route condition according to the use level.

When the route condition includes the start position of the route, the route condition acquiring unit 120D refers to the route condition database 800 using, for example, the use level for each user, and determines the position in the projection area according to the use level, thereby acquiring the start position of the route in the projection area.

When the route condition includes a scheduled length that is the length of the route to be projected on the area indicated by the area information, the route condition acquiring unit 120D refers to the route condition database 800 using the use level, for example, and acquires the scheduled length according to the use level.

When the route condition includes the number of direction changes of the route to be projected on the area indicated by the area information, the route condition acquiring unit 120D refers to the route condition database 800 using the use level, for example, and acquires the number of direction changes according to the use level.

When the route condition acquiring unit 120D acquires the route condition using the user position and the use level, for example, the route condition acquiring unit 120D acquires the start position of the route similarly to the above using the user position information, acquires the scheduled length similarly to the above using the use level, and acquires the number of direction changes similarly to the above using the use level.

Note that the route condition acquiring unit 120D in the information processing device 100D may be replaced with the already described route condition acquiring unit 120 in a case where it is sufficient to have only the function of the already described route condition acquiring unit 120.

The mark acquiring unit 130D acquires a mark condition related to the mark.

The mark included in the mark condition is one type of mark or a plurality of types of marks.

The mark condition includes identification information of the mark and an arrangement interval of each mark.

The mark acquiring unit 130D acquires the mark condition using the use level. Specifically, the mark acquiring unit 130D refers to the mark condition database 900 using the use level to acquire the mark condition according to the use level.

Note that the mark acquiring unit 130D in the information processing device 100D may be replaced with the mark acquiring unit 130 described above in a case where it is sufficient to have only the function of the mark acquiring unit 130 described above.

The information processing unit 140D generates and outputs an image in which marks satisfying the mark condition are arranged along a route satisfying the route condition in the projection area.

The information processing unit 140D generates and outputs an image in which marks are arranged so as to satisfy the mark condition in an area other than an area where a shadow due to a user occurs when the user is present in the projection area along a route satisfying the route condition in the projection area.

As the detailed configuration example of the information processing unit 140D, any of the detailed configuration examples of the information processing units 140A, 140B, and 140C described above can be applied.

That is, the information processing unit 140D includes the route generating unit 141, the mark arranging unit 142 or the mark arranging unit 142C, and the image generating unit 143.

In the description, the information processing unit 140D has a configuration including the route generating unit 141, the mark arranging unit 142C, and the image generating unit 143.

The route generating unit 141 generates a route satisfying the route condition in the projection area, similarly to the route generating unit 141 described above.

Specifically, the route generating unit 141 acquires route components from route components stored in advance so as to satisfy the route condition in the range of the projection area indicated by the area information, and connects the route components to generate a route.

More specifically, the route generating unit 141 acquires the area information and the route condition, refers to the route database 300 using the area information and the route condition, and acquires the route component from among the route components stored in the route database 300 so as to satisfy the route condition in the range of the projection area indicated by the area information. The route generating unit 141 generates a route by combining the acquired route components and connecting routes in the route components. The route generating unit 141 outputs route information indicating the generated route.

The mark arranging unit 142C arranges the marks along the route generated by the route generating unit 141, similarly to the mark arranging unit 142C described above.

Specifically, for example, the mark arranging unit 142C acquires mark information satisfying the mark condition from the mark information stored in advance, and arranges a mark along the route generated by the route generating unit 141 using the mark information. A single or a plurality of marks is arranged. Further, there are one type or a plurality of types of marks to be arranged.

More specifically, the mark arranging unit 142C acquires the mark condition, refers to the mark database 400 using the mark condition, and acquires the mark information satisfying the mark condition. The mark arranging unit 142C arranges the mark along the route generated by the route generating unit 141 using the acquired mark information.

Further, when arranging the mark, the mark arranging unit 142C arranges the mark on a route where no shadow occurs in the route.

Specifically, the mark arranging unit 142C refers to the shadow occurrence route database 500 using, for example, route information indicating a route generated by the route generating unit 141, and arranges the mark in the route other than a shadow occurrence route in which a shadow occurs.

More specifically, for example, the mark arranging unit 142C acquires a shadow occurrence route indicating a route pattern in which a shadow due to the presence of the user occurs, and arranges the mark along a route other than the route pattern of the shadow occurrence route among routes generated by the route generating unit 141.

The mark arranging unit 142C outputs arranged mark information indicating all the arranged marks.

The image generating unit 143 outputs an image including the mark arranged by the mark arranging unit 142C, similarly to the image generating unit 143 described above.

Specifically, for example, the image generating unit 143 superimposes and outputs an image indicating the route generated by the route generating unit 141 and an image indicating the mark arranged by the mark arranging unit 142C.

More specifically, the image generating unit 143 acquires the route information indicating the route generated by the route generating unit 141, and acquires the arranged mark information indicating all the arranged marks arranged by the mark arranging unit 142C. The image generating unit 143 generates a route image indicating the route using the route information. The image generating unit 143 generates an arranged mark image indicating arranged marks arranged according to the projection area using the arranged mark information. The image generating unit 143 outputs a projection image, which is an image obtained by superimposing the route image and the arranged mark image, to the projecting device 200D.

The projecting device 200D has functions similar to those of the projecting devices 200A, 200B, and 200C described above. The projecting device 200D illustrated in FIG. 17 receives an image generated and output by the image generating unit 143 in the information processing unit 140D of the information processing device 100D, and projects the received image by outputting the received image to a projection target such as a floor surface.

Similarly to the route database 300 described above, the route database 300 stores route component information regarding route components.

Specifically, the route database 300 includes information regarding route components with which an image of a continuous route can be generated in the projection area by connecting a plurality of route components such as a start point of a route in route components, an end point of the route in the route components, a length of the route in the route components, a shape of the route in the route components, and the number of direction changes of the route in the route components, and stores the information as the route component information in association with each other.

The start point of a route and the end point of the route are, for example, information indicated by coordinates of the start point and coordinates of the end point with respect to a reference point in a route component image.

The length of the route is a length along a route from the start point to the end point in the route component image.

The shape of the route is, for example, information indicated in the form of a coordinate group indicating a boundary that separates the route and the rest in the route component image. Alternatively, for example, the image itself indicating the shape of the route in the route component may be used.

The number of direction changes of the route is information indicating the number of direction changes along the route in the route component image. For example, when the route is straight, the number of direction changes is “0”, and when the route is L-shaped, the number of direction changes is “1”. Note that, in a case where the route draws a curve, the number of direction changes may be “1” from the start point to the end point of the curve in the route, or the number of changes in direction per fixed length.

Note that, although a mode in which a route component stored in the route database 300 provided outside the information processing device 100D is used will be described here, the route database 300 may be included inside the information processing device 100D.

Similarly to the mark database 400 described above, the mark database 400 stores mark information for each mark type for a plurality of types of marks.

Specifically, the mark database 400 stores the mark identification information and the mark image in association with each other.

The types of marks include figures, characters, and the like.

The figures include a circle, a quadrangle, a triangle, a pentagon, a hexagon, a star, a fruit shape, and the like.

The characters include hiragana, katakana, various numbers, and characters used in each region in the world.

Note that, here, a mode in which marks stored in the mark database 400 provided outside the information processing device 100D are used will be described, but the mark database 400 may be included inside the information processing device 100D.

The shadow occurrence route database 500 stores the shadow occurrence route similarly to the shadow occurrence route database 500 described above.

The shadow occurrence route indicates a route pattern in which a shadow due to the presence of the user occurs.

Specifically, the shadow occurrence route database 500 stores shadow occurrence route information indicating a route pattern of the shadow occurrence route. The shadow occurrence route information is information such as a start point of the shadow occurrence route in shadow occurrence route components, an end point of the shadow occurrence route in the shadow occurrence route components, a traveling direction of the shadow occurrence route in the shadow occurrence route components, a length of the shadow occurrence route in the shadow occurrence route components, and a shape of the shadow occurrence route in the shadow occurrence route components, similarly to the form of the information regarding the route component in the route database. Further, the shadow occurrence route information may include a position where a shadow of the user is likely to be generated for each position in the projection area using the relationship between the position of the projecting device 200D and the projection area. Thus, a mark can be arranged on a route pattern in which a shadow does not occur depending on the position of the route in the projection area among the route patterns indicated by the shadow occurrence route.

Note that, here, a form using the shadow occurrence route stored in the shadow occurrence route database 500 provided outside the information processing device 100D will be described, and thus the shadow occurrence route database 500 may be included inside the information processing device 100D.

The user information database 600 stores the user identification information and the use level in association with each other.

The use level of the user information database 600 is used to acquire, for example, information such as an area having a size according to the use level of the user, a route condition according to the use level of the user, and a mark condition according to the use level of the user.

Specifically, the user information database 600 stores the user identification information and use level information indicating the use level in association with each other.

The area database 700 stores the use level and area information indicating an area having a size according to the use level in association with each other.

Specifically, the area database 700 stores the use level information indicating the use level and the area information in association with each other.

Alternatively, the area database 700 stores the user identification information and the area information indicating the area having the size corresponding to the user in association with each other.

Specifically, the area database 700 stores the user identification information and the area information in association with each other.

The route condition database 800 stores the use level and the route condition in association with each other.

Specifically, the route condition database 800 stores the use level information indicating the use level and the route condition information indicating the route condition in association with each other.

Alternatively, the route condition database 800 stores the user identification information and the route condition in association with each other. Specifically, the route condition database 800 stores the user identification information and the route condition information indicating the route condition in association with each other.

The route condition database 800 stores one type of condition or a plurality of types of conditions in association with each other for each use level or each user.

The mark condition database 900 stores the use level and the mark condition in association with each other.

Specifically, the mark condition database 900 stores the use level information indicating the use level and the mark condition information indicating the mark condition in association with each other.

Alternatively, the mark condition database 900 stores the user identification information and the mark condition in association with each other.

Specifically, the mark condition database 900 stores the user identification information and the mark condition information indicating the mark condition in association with each other.

The mark condition database 900 stores one type of mark condition or a plurality of types of conditions in association with each other for each use level or each user.

The sensor device 1000 is a device that senses a position where a living body (user) exists in the projection area by the projecting device 200 and the peripheral area of the projection area. The sensor device 1000 outputs a sensor signal indicating a sensing result.

Further, in addition to the above, the sensor device 1000 may be a device that senses the front direction in which the living body (user) is facing.

The sensor signal output from the sensor device 1000 is used when the information processing device 100D acquires the start position of the route.

An example of processing of the information processing device 100D will be described. Further, an example of an image output as a result of the processing of the information processing device 100D will be described.

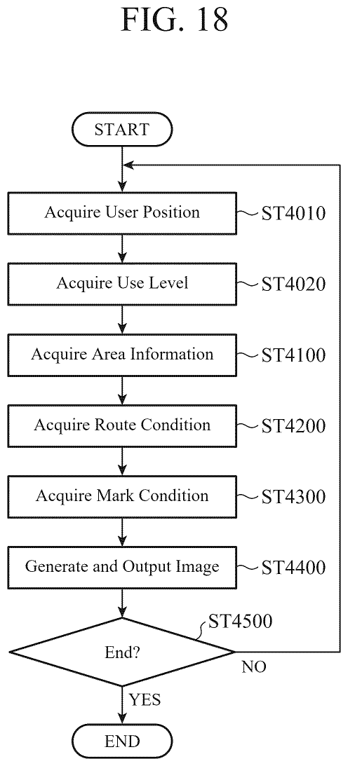

FIG. 18 is a flowchart illustrating an example of processing of the information processing device 100D according to the fourth embodiment of the present disclosure.

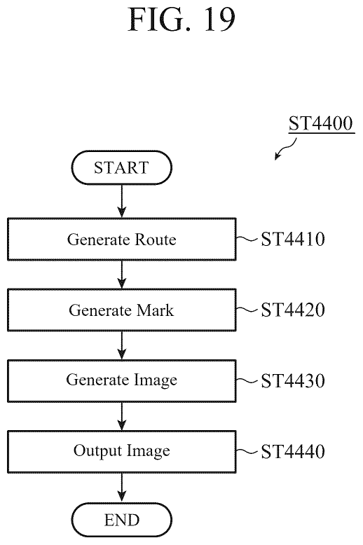

FIG. 19 is a flowchart illustrating an example of image generation output processing in processing of the information processing device 100D according to the fourth embodiment of the present disclosure.

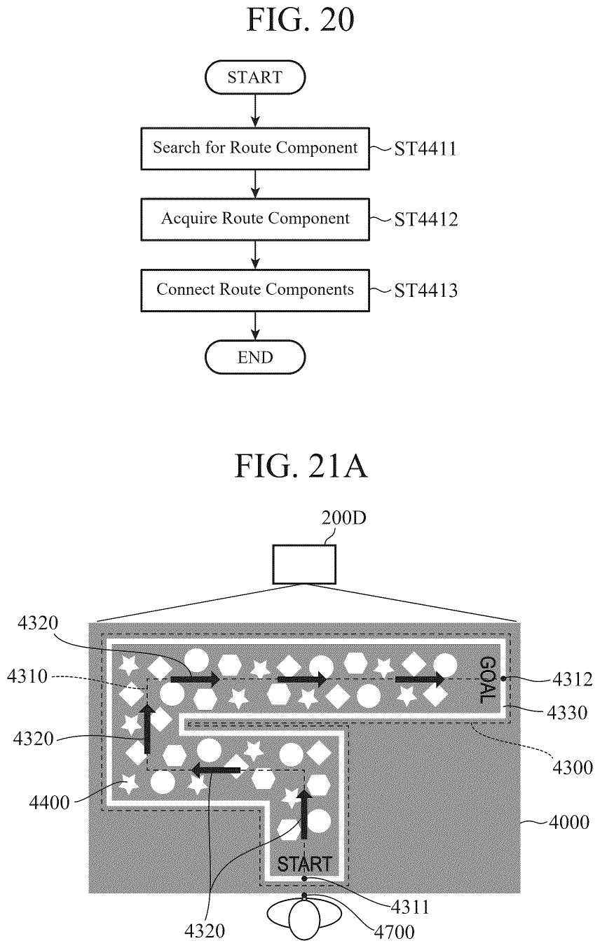

FIG. 20 is a flowchart illustrating an example of route generation processing in the processing of the information processing device 100D according to the fourth embodiment of the present disclosure.

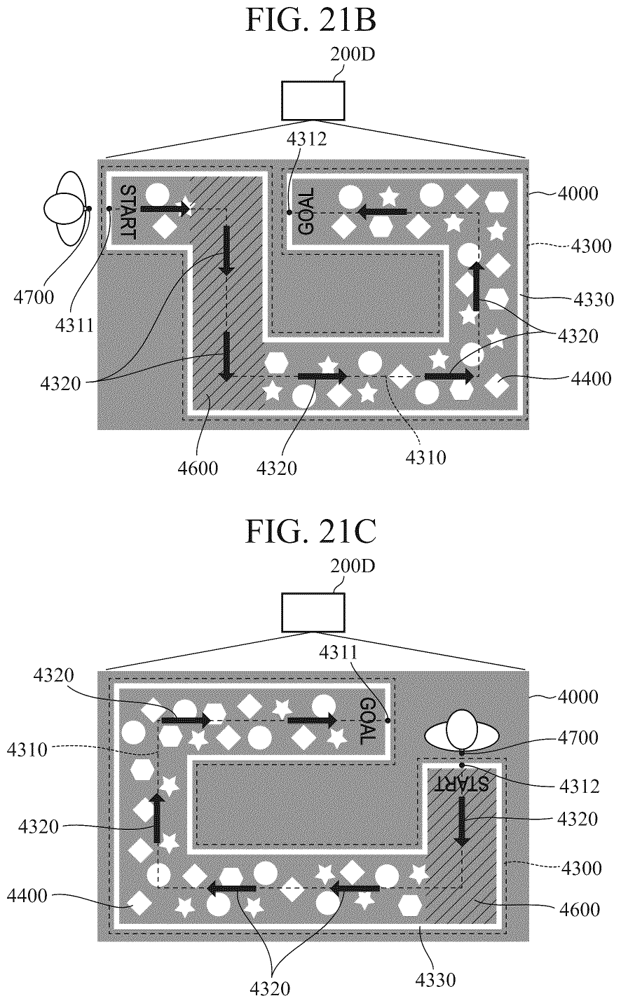

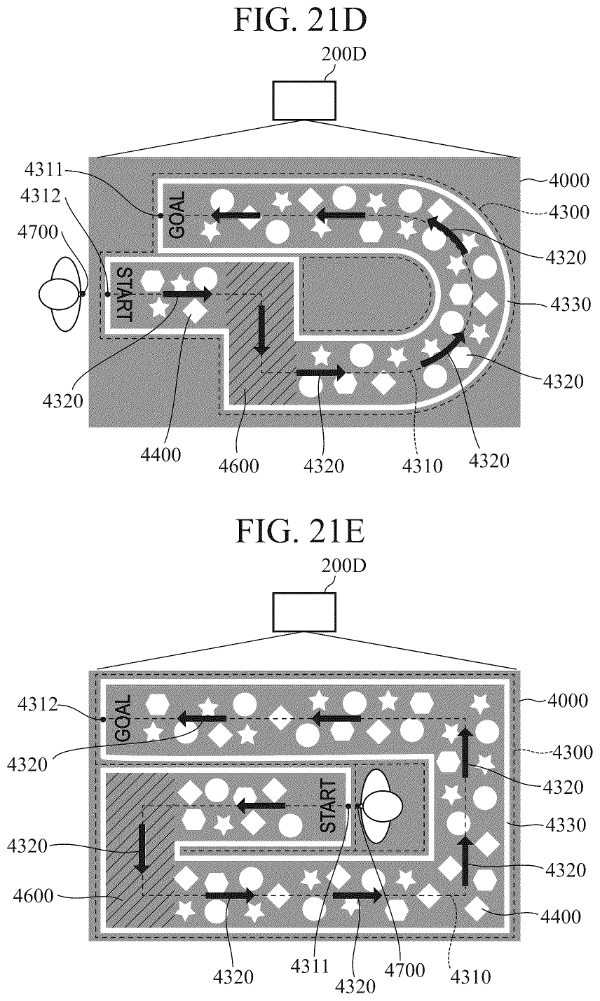

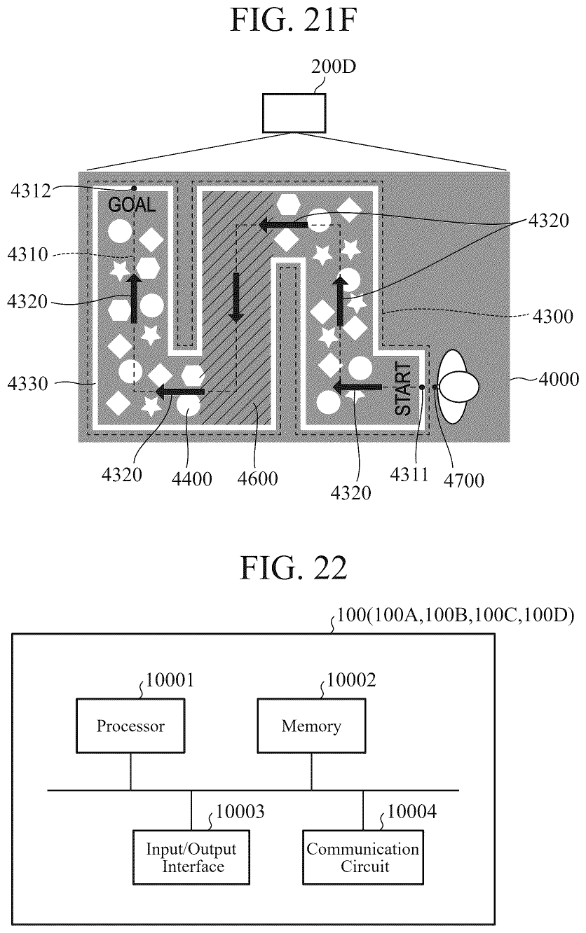

FIGS. 21A, 21B, 21C, 21D, 21E, and 21F are diagrams illustrating example 1 of an image output by the information processing device 100D according to the fourth embodiment of the present disclosure or an image projected in the image projecting system 1D. FIGS. 21A, 21B, 21C, 21D, 21E, and 21F may be simply referred to as FIG. 21 when collectively described.

In the process illustrated in FIG. 18, the information processing device 100D executes user position acquisition processing (step ST4010).

In the user position acquisition processing, the user position acquiring unit 160 of the information processing device 100D acquires user position information indicating the position of the user on the basis of the sensor signal.

The user position acquiring unit 160 first receives and acquires the sensor signal from the sensor device 1000.

Next, the user position acquiring unit 160 acquires the user position information indicating the position of the user by detecting the position of the user using the acquired sensor signal.

Next, the user position acquiring unit 160 outputs the acquired user position information to the route condition acquiring unit 120D.

The position of the user indicated by the user position information is, for example, a position corresponding to an end face in a direction in which the face of the user faces, such as a user position 4700 illustrated in FIG. 21.

The information processing device 100D executes use level acquisition processing (step ST4020).

In the use level acquisition processing, the use level acquiring unit 150 of the information processing device 100D acquires the use level for each user.

The use level acquiring unit 150 first receives user identification information for identifying the user.

Next, upon receiving the user identification information, the use level acquiring unit 150 refers to the user information database 600 using the user identification information to acquire the use level information indicating the use level.

Next, the use level acquiring unit 150 outputs the acquired use level information to the area information acquiring unit 110D, the route condition acquiring unit 120D, and the mark acquiring unit 130D.

Note that the use level acquiring unit 150 may be configured to output to some of the area information acquiring unit 110D, the route condition acquiring unit 120D, and the mark acquiring unit 130D.

The information processing device 100D executes area information acquisition processing (step ST4100).

In the area information acquisition processing, the area information acquiring unit 110D of the information processing device 100D acquires area information regarding the projection area of the projecting device 200.

The area information acquiring unit 110D acquires, for example, area information stored in advance.

The area information acquiring unit 110D outputs the acquired area information to the information processing unit 140D.

The area information is, for example, information regarding a projection area 4000 illustrated in FIG. 21.

The information processing device 100D executes route condition acquisition processing (step ST4200).

In the route condition acquisition processing, the route condition acquiring unit 120D of the information processing device 100D acquires a route condition of a route to be projected on the area indicated by the area information.

The route condition acquiring unit 120D acquires route condition information indicating route conditions such as a start position, a scheduled length, and the number of direction changes, for example.

When the route condition acquiring unit 120D acquires the start position, for example, the route condition acquiring unit 120D receives the user position information from the user position acquiring unit 160, and acquires start position information indicating the start position determined using the user position indicated by the user position information.

When the route condition acquiring unit 120D acquires the scheduled length and the number of direction changes, for example, upon receiving the use level information indicating the use level from the use level acquiring unit 150, the route condition acquiring unit 120D refers to the route condition database 800 using the use level information, and acquires the route condition information indicating the scheduled length according to the use level and the number of direction changes.

The information processing device 100D executes mark condition acquisition processing (step ST4300).

In the mark condition acquisition processing, the mark acquiring unit 130D of the information processing device 100D acquires the mark condition related to the mark.

Upon receiving the use level information indicating the use level from the use level acquiring unit 150, the mark acquiring unit 130D refers to the mark database 400 using the use level information and acquires the mark condition information indicating the mark condition according to the use level.

The information processing device 100D executes image generation output processing (step ST4400).

In the image generation output processing, the information processing unit 140D of the information processing device 100D generates and outputs an image in which marks satisfying the mark condition are arranged along a route satisfying the route condition in the projection area.

The information processing unit 140D generates and outputs an image in which marks are arranged so as to satisfy the mark condition in an area other than an area where a shadow due to a user occurs when the user is present in the projection area along a route satisfying the route condition in the projection area.

A detailed example of the image generation output processing will be described with reference to FIG. 19.

The information processing unit 140D executes the route generation processing in the image generation output processing (step ST4410).

Specifically, the route generating unit 141 of the information processing unit 140D acquires route components from route components stored in advance so as to satisfy the route condition in the range of the projection area indicated by the area information, and connects the route components to generate a route.

A detailed example of the route generation processing will be described with reference to FIG. 20.

Upon starting the processing, the route generating unit 141 executes route component search processing (step ST4411).

In the route component search processing, the route generating unit 141 first acquires the area information from the area information acquiring unit 110D, and acquires the route condition information indicating route conditions including a start position from the route condition acquiring unit 120D. Next, the route generating unit 141 refers to the route database using the route conditions indicated in the route condition information and searches for a route component satisfying the route condition. At this time, a plurality of route components capable of generating a route whose direction changes by the number of direction changes is searched for with the scheduled length as a route length within the range of the projection area from the start position included in the route conditions. Further, in a case where the search condition includes the shape of the route, a route component having the shape of the route included in the search condition is further searched for. A search result includes information indicating a position where each route component is arranged in the projection area or an order of connection.

The route generating unit 141 executes route component acquisition processing (step ST4412).

In the route component acquisition processing, the route generating unit 141 acquires a route component from among the route components stored in the route database on the basis of the search result of the route component so as to satisfy the route condition in the range of the projection area indicated by the area information.

Specifically, the route generating unit 141 acquires the route component information regarding route components from the route database for each route component indicated in the search result. The route component information includes information indicating a position where each route component is arranged in the projection area or an order of connection.

The route generating unit 141 executes route component connection processing (step ST4413).

In the route component connection processing, the route generating unit 141 generates a route by connecting the end point indicated in each route component and the start point other than a beginning point using the acquired route component.

Specifically, the route generating unit 141 connects each route component by using information indicating a position of arrangement in the projection area or an order of connection included in the route component information for each route component, and generates route information indicating a route after connection.

The route generating unit 141 outputs route information indicating the generated route to the mark arranging unit 142C and the image generating unit 143. The description returns to FIG. 19.

In the image generation output processing, the information processing unit 140D executes the mark generation processing similarly to the mark generation processing (see FIG. 14 and the description thereof) of the information processing unit 140C described above (step ST4420).

In the mark generation processing, the mark arranging unit 142C of the information processing unit 140D first executes mark search processing (“step ST3421” in FIG. 14). In the mark search processing, the mark arranging unit 142C executes mark search processing of searching for mark information satisfying the mark condition from the mark information stored in advance. Specifically, upon receiving the mark condition from the mark acquiring unit 130, the mark arranging unit 142C refers to the mark database 400 using the mark condition and searches for mark information satisfying the mark condition.

Next, the mark arranging unit 142C executes mark acquisition processing of acquiring the mark information as a search result (“step ST3422” in FIG. 14).

Next, the mark arranging unit 142C executes shadow occurrence route acquisition processing (“step ST3423” in FIG. 14). Specifically, the mark arranging unit 142C refers to the shadow occurrence route database 500 using the route information indicating the route generated by the route generating unit 141, and acquires a shadow occurrence route indicating a route pattern in which a shadow occurs due to the presence of the user.

Next, the mark arranging unit 142C executes mark arrangement processing (“step ST3424” in FIG. 14). In the mark arrangement processing, the mark arranging unit 142C arranges the mark so as to avoid a shadow occurrence route in which a shadow may occur in the route. Specifically, the mark arranging unit 142C arranges the mark along a route other than the route pattern of the shadow occurrence route among the routes generated by the route generating unit 141 using the shadow occurrence route. The mark arranging unit 142C outputs arranged mark information indicating all the arranged marks.

The information processing unit 140D executes image generation processing in the image generation output processing (step ST4430).

In the image generation processing, the image generating unit 143 of the information processing unit 140D superimposes and outputs the image indicating the route generated by the route generating unit 141 and the image indicating the mark arranged by the mark arranging unit 142C.

Specifically, the image generating unit 143 first acquires route information indicating a route from the route generating unit 141, and acquires arranged mark information indicating all the arranged marks from the mark arranging unit 142C. Next, the image generating unit 143 generates a route image indicating a route using the route information, and generates an arranged mark image indicating a mark after arrangement using the arranged mark information. Next, the image generating unit 143 generates a projection image in which the route image and the arranged mark image are superimposed.

The information processing unit 140D executes image output processing in the image generation output processing (step ST4440).

In the image output processing, the image generating unit 143 of the information processing unit 140D outputs the generated projection image to the projecting device 200D.

After executing the image output processing, the information processing unit 140D ends the image generation output processing.

The description returns to FIG. 18.

The information processing device 100D determines whether to end the processing (step ST4500).

If it is determined not to end the processing (step ST4500 “NO”), the information processing device 100D returns to the processing of step ST4010 and repeats the processing operation from the processing of step ST4010.

If it is determined to end the processing (step ST4500 “YES”), the information processing device 100D ends the processing.

An example of an image generated by the information processing device 100D will be described.

FIG. 21 illustrates a projection area 4000, a route image 4300, a route length 4310, a start position 4311, an end position 4312, a traveling direction 4320, a route shape 4330, arranged marks 4400, a shadow occurrence route 4600, and a user position (user front position) 4700.

The route image 4300 indicates a route generated by combining and connecting a plurality of route components 2100 as illustrated in FIG. 9 described above.

The route length 4310 is a length from the start position 4311 to the end position 4312 of the route, and corresponds to a length obtained by combining the route component lengths 2110 of the route components 2100 used when generating the route so as to satisfy the route condition.

The start position 4311 is a position determined by calculating a position close to the user position with reference to the user position in the range of the projection area on the basis of the user position (user front position) 4700.

The traveling direction 4320 indicates a direction to travel from the start position 4311 toward the end position 4312 in the route. The traveling direction 4320 need not be included in the image.

The route shape 4330 is a shape determined according to the search condition when the route shape 4330 is included in the search condition.

The arranged mark 4400 is all the marks arranged by the mark arranging unit 142C and displayed on the route along the route. In a case where the route image is, for example, an image for walking training, the arranged mark 4400 is used as a mark for allowing the user to touch with the sole of the foot.

The arranged mark 4400 is arranged avoiding the shadow occurrence route 4600 in the route indicated by the route image 4300.

The shadow occurrence route 4600 collates whether the route of the route image 4300 corresponds to the shadow occurrence route component 4100 as illustrated in FIG. 15, and indicates an area corresponding to the shadow occurrence route component 3100 in the route of the route image 4300.

FIGS. 21A, 21B, 21C, 21D, 21E, and 21F illustrate that the route image 4300 in which the position close to the user position 4700 is set to the start position 4311 of the route is generated and the projection image including the route image 4300 is output regardless of whether the user exists around or inside the projection area.

The information processing device of the present disclosure is further configured as follows.

“An information processing device including:
a user position acquiring unit to acquire user position information indicating a position of a user on a basis of a sensor signal, in which
the route condition includes a start position of a route in the projection area, and
the route condition acquiring unit acquires the start position using the user position information.”

Thus, the present disclosure has an effect that it is possible to further provide an information processing device capable of generating an image indicating a route in which a position corresponding to a position of a user is set as a start position with respect to the image projected on the projection area.

Furthermore, the present disclosure has an effect similar to the above effect by applying the above configuration to the above information processing method or the above image projecting system.

The information processing device of the present disclosure is further configured as follows.

“The information processing device, in which the route condition further includes:
a scheduled length that is a length of a route to be projected on the area indicated by the area information, or
a number of direction changes of a route to be projected on the area indicated by the area information.”

Thus, the present disclosure has an effect that it is possible to further provide an information processing device capable of generating an image indicating a route suitable for the user with respect to the image projected on the projection area.

Furthermore, the present disclosure has an effect similar to the above effect by applying the above configuration to the above information processing method or the above image projecting system.

The information processing device of the present disclosure is further configured as follows.

“The information processing device, further including:
a use level acquiring unit to acquire a use level for each of users, wherein
the route condition acquiring unit acquires the route condition using the use level.”

Thus, the present disclosure has an effect that it is possible to further provide an information processing device that makes a route in the projection area variable on the basis of a route condition according to a use level for each user with respect to the image projected on the projection area.

Furthermore, the present disclosure has an effect similar to the above effect by applying the above configuration to the above information processing method or the above image projecting system.

The information processing device of the present disclosure is further configured as follows.

“The information processing device, in which the mark condition includes identification information of a mark and an arrangement interval of each of marks.”

Thus, the present disclosure has an effect that it is possible to further provide an information processing device capable of generating an image indicating marks of types and at arrangement intervals suitable for the user with respect to the image projected on the projection area.

Furthermore, the present disclosure has an effect similar to the above effect by applying the above configuration to the above information processing method or the above image projecting system.

The information processing device of the present disclosure is further configured as follows.

“The information processing device, further including:
a use level acquiring unit to acquire a use level for each of users, wherein
the mark acquiring unit acquires the mark condition using the use level.”

Thus, the present disclosure has an effect that it is possible to further provide an information processing device that makes a mark in the projection area variable on the basis of a mark condition according to a use level for each user with respect to the image projected on the projection area.

Furthermore, the present disclosure has an effect similar to the above effect by applying the above configuration to the above information processing method or the above image projecting system.

Here, a hardware configuration that implements the functions of the information processing device of the present disclosure will be described.

FIG. 22 is a diagram illustrating a first example of a hardware configuration for implementing the functions of the information processing devices 100, 100A, 100B, 100C, and 100D of the present disclosure.

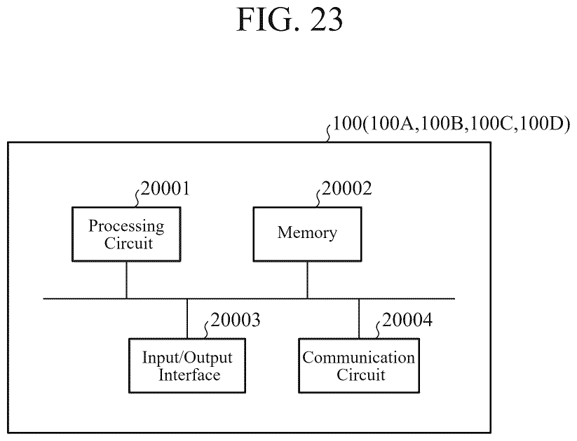

FIG. 23 is a diagram illustrating a second example of a hardware configuration for implementing the functions of the information processing devices 100, 100A, 100B, 100C, and 100D of the present disclosure.

The information processing device of the present disclosure is implemented by hardware as illustrated in FIG. 22 or 23.

As illustrated in FIG. 22, the information processing devices 100, 100A, 100B, 100C, and 100D include, for example, a processor 10001, a memory 10002, and a communication circuit 10004.

The processor 10001 and the memory 10002 are mounted on a computer, for example.

The memory 10002 stores programs for causing the computer to function as area information acquiring units 110 and 110D, route condition acquiring units 120 and 120D, mark acquiring units 130 and 130D, information processing units 140, 140B, 140C, and 140D, a route generating unit 141, mark arranging units 142 and 142C, an image generating unit 143, a use level acquiring unit 150, a user position acquiring unit 160, and a control unit which is not illustrated. The processor 10001 reads and executes the program stored in the memory 10002, thereby implementing the functions of the area information acquiring units 110 and 110D, the route condition acquiring units 120 and 120D, the mark acquiring units 130 and 130D, the information processing units 140, 140B, 140C, and 140D, the route generating unit 141, the mark arranging units 142 and 142C, the image generating unit 143, the use level acquiring unit 150, the user position acquiring unit 160, and the control unit which is not illustrated.

Further, a storage unit that is not illustrated is implemented by the memory 10002 or another memory that is not illustrated. Furthermore, in a case where the information processing devices 100, 100A, 100B, 100C, and 100D include the route databases 300 and 300B, the mark database 400, the shadow occurrence route database 500, the user information database 600, the area database 700, the route condition database 800, or the mark condition database 900, the route databases 300 and 300B, the mark database 400, the shadow occurrence route database 500, the user information database 600, the area database 700, the route condition database 800, and the mark condition database 900 are implemented by the memory 10002 or another memory which is not illustrated.

Further, a communication unit which is not illustrated is implemented by the communication circuit 10004.

The processor 10001 uses, for example, a central processing unit (CPU), a graphics processing unit (GPU), a microprocessor, a microcontroller, a digital signal processor (DSP), or the like.

The memory 10002 may be a nonvolatile or volatile semiconductor memory such as a random access memory (RAM), a read only memory (ROM), an erasable programmable read only memory (EPROM), an electrically erasable programmable read only memory (EEPROM), a flash memory, or the like, a magnetic disk such as a hard disk or a flexible disk, or an optical disk such as a compact disc (CD) or a digital versatile disc (DVD).

The processor 10001 and the memory 10002 or the communication circuit 10004 are connected in a state capable of transmitting data to each other. Further, the processor 10001, the memory 10002, and the communication circuit 10004 are connected in a state in which data can be mutually transmitted with other hardware via the input/output interface 10003.

Alternatively, the functions of the area information acquiring units 110 and 110D, the route condition acquiring units 120 and 120D, the mark acquiring units 130 and 130D, the information processing units 140, 140B, 140C, and 140D, the route generating unit 141, the mark arranging units 142 and 142C, the image generating unit 143, the use level acquiring unit 150, the user position acquiring unit 160, and the control unit which is not illustrated may be implemented by a dedicated processing circuit 20001 as illustrated in FIG. 23.

Further, a communication unit which is not illustrated is implemented by the communication circuit 10004.

The processing circuit 20001 uses, for example, a single circuit, a composite circuit, a programmed processor, a parallel programmed processor, an application specific integrated circuit (ASIC), a programmable logic device (PLD), a field-programmable gate array (FPGA), a system-on-a-chip (SoC), a system large-scale integration (LSI), or the like.

Further, a storage unit that is not illustrated is implemented by the memory 20002 or another memory that is not illustrated.

The memory 20002 may be a nonvolatile or volatile semiconductor memory such as a random access memory (RAM), a read only memory (ROM), an erasable programmable read only memory (EPROM), an electrically erasable programmable read only memory (EEPROM), a flash memory, or the like, a magnetic disk such as a hard disk or a flexible disk, or an optical disk such as a compact disc (CD) or a digital versatile disc (DVD) or a magnetic optical disk.

Furthermore, a communication unit which is not illustrated is implemented by the communication circuit 20004.

The processing circuit 20001 and the memory 20002 or the communication circuit 20004 are connected in a state capable of transmitting data to each other. Further, the processing circuit 20001, the memory 20002, and the communication circuit 20004 are connected in a state in which data can be mutually transmitted with other hardware via the input/output interface 20003.

Note that the functions of the area information acquiring units 110 and 110D, the route condition acquiring units 120 and 120D, the mark acquiring units 130 and 130D, the information processing units 140, 140B, 140C, and 140D, the route generating unit 141, the mark arranging units 142 and 142C, the image generating unit 143, the use level acquiring unit 150, the user position acquiring unit 160, and the control unit which is not illustrated may be implemented by different processing circuits, or may be collectively implemented by a processing circuit.

Alternatively, some of the functions of the area information acquiring units 110 and 110D, the route condition acquiring units 120 and 120D, the mark acquiring units 130 and 130D, the information processing units 140, 140B, 140C, and 140D, the route generating unit 141, the mark arranging units 142 and 142C, the image generating unit 143, the use level acquiring unit 150, the user position acquiring unit 160, and the control unit which is not illustrated may be implemented by the processor 10001 and the memory 10002, and the remaining functions may be implemented by the processing circuit 20001.

Note that the present disclosure can freely combine the respective embodiments, modify any component of the respective embodiments, or omit any component of the respective embodiments within the scope of the invention.

### INDUSTRIAL APPLICABILITY

The information processing device according to the present disclosure is suitable for use in an image projecting system that projects an image by a projector or the like because a route in the projection area can be made variable with respect to the image projected on the projection area.

### REFERENCE SIGNS LIST

1, 1A, 1B, 1C, 1D: image projecting system, 100, 100A, 100B, 100C, 100D: information processing device, 110, 110D: area information acquiring unit, 120, 120D: route condition acquiring unit, 130, 130D: mark acquiring unit, 140, 140B, 140C, 140D: information processing unit, 141: route generating unit, 142, 142C: mark arranging unit, 143: image generating unit, 150: use level acquiring unit, 160: user position acquiring unit, 200, 200A, 200B, 200C, 200D: projecting device (output device), 300, 300B: route database, 400: mark database, 500: shadow occurrence route database, 600: user information database, 700: area database, 800: route condition database, 900: mark condition database, 1000: sensor device, 2000: projection area, 2100: route component, 2110: route component length, 2111: start point, 2112: end point, 2120: traveling direction, 2130: route component shape, 2200: mark, 2300: route image, 2310: route length, 2311: start position, 2312: end position, 2320: traveling direction, 2330: route shape, 2400: arranged mark, 3000: projection area, 3100: shadow occurrence route component, 3110: shadow occurrence route component length, 3111: start point, 3112: end point, 3120: traveling direction, 3130: shadow occurrence route shape, 3300: route image, 3310: route length, 3311: start position, 3312: end position, 3330: route shape, 3400: arranged mark, 3600: shadow occurrence route, 4000: projection area, 4300: route image, 4310: route length, 4311: start position, 4312: end position, 4320: traveling direction, 4330: route shape, 4400: arranged mark, 4600: shadow occurrence route, 4700: user position (user front position), 10001: processor, 10002: memory, 10003: input/output interface, 10004: communication circuit, 20001: processing circuit, 20002: memory, 20003: input/output interface, 20004: communication circuit

1. An information processing device comprising:
a processor; and
a memory storing a program, upon executed by the processor, to perform the process:
to acquire area information regarding a projection area of a projecting device;
to acquire a route condition of a route to be projected on an area indicated by the area information;
to acquire a mark condition regarding a mark; and
to generate and output an image in which a mark satisfying the mark condition is arranged along a route satisfying the route condition in the projection area.

2. The information processing device according to claim 1, wherein
the process generates and outputs an image in which a mark is arranged so as to satisfy the mark condition in an area other than an area where a shadow due to a user occurs when the user is present in the projection area along a route satisfying the route condition in the projection area.

3. The information processing device according to claim 1, wherein the process includes:
to acquire a route component from route components stored in advance and connect the route component to generate a route so as to satisfy the route condition in a range of a projection area indicated by the area information;
to acquire mark information satisfying the mark condition from mark information stored in advance and arrange a mark along a route generated by using the mark information; and
to output an image indicating the route generated and an image indicating the mark arranged in a superimposed manner.

4. The information processing device according to claim 3, wherein
the process acquires the route component indicating a route pattern in which a shadow due to presence of a user does not occur.

5. The information processing device according to claim 3, wherein
the process acquires a shadow occurrence route indicating a route pattern in which a shadow due to presence of a user occurs, and arranges the mark along the route other than the route pattern of the shadow occurrence route among routes generated.

6. The information processing device according to claim 1, wherein the route condition includes:
a scheduled length that is a length of a route to be projected on an area indicated in the area information;
a start position of a route to be projected on an area indicated in the area information; or
a number of direction changes of a route to be projected on an area indicated in the area information.

7. The information processing device according to claim 1, further comprising:
to acquire user position information indicating a position of a user on a basis of a sensor signal, wherein
the route condition includes a start position of a route in the projection area, and
the process acquires the start position using the user position information.

8. The information processing device according to claim 7, wherein the route condition further includes:
a scheduled length that is a length of a route to be projected on the area indicated by the area information, or
a number of direction changes of a route to be projected on the area indicated by the area information.

9. The information processing device according to claim 1, further comprising:
to acquire a use level for each of users, wherein
the process acquires the route condition using the use level.

10. The information processing device according to claim 1, wherein
the mark condition includes identification information of a mark and an arrangement interval of each of marks.

11. The information processing device according to claim 10, further comprising:
to acquire a use level for each of users, wherein
the process acquires the mark condition using the use level.

12. An information processing method comprising:
acquiring area information regarding a projection area of a projecting device;
acquiring a route condition of a route to be projected on an area indicated by the area information;
acquiring a mark condition regarding a mark; and
generating and outputting an image in which a mark satisfying the mark condition is arranged along a route satisfying the route condition in the projection area.

13. An image projecting system comprising:
an information processing device including:
a processor; and
a memory storing a program, upon executed by the processor, to perform a process:
to acquire area information regarding a projection area of a projecting device;
to acquire a route condition of a route to be projected on an area indicated by the area information;
to acquire a mark condition regarding a mark; and
to generate and output an image in which a mark satisfying the mark condition is arranged along a route satisfying the route condition in the projection area; and
a projecting device to project the image output by the information processing device.
